(19) United States
(12) Patent Application Publication
(10) Pub. No.: US 2019/0339672 A1
(43) Pub. Date: Nov. 7, 2019

(54) Food Distribution System

(71) Applicant: Frederic Speed Bancroft, Baton Rouge, LA (US)

(72) Inventor: Frederic Speed Bancroft, Baton Rouge, LA (US)

(21) Appl. No.: 15/947,776

(22) Filed: May 7, 2018

(51) Int. Cl. G05B 19/418; G06Q 10/08; B60P 3/00; G05D 1/00

(52) U.S. Cl. CPC G05B 19/418; G06Q 10/0832; G06Q 50/28; G05D 1/0027; B60P 3/00

(57) ABSTRACT

This is an automatic food preparation system comprised of four subsystems: (1) a trailer management system, (2) an inventory management system, (3) a food preparation system, and (4) a user interface system for ordering pre-prepared foods. The trailer management system is a networked computer system that allows the management of multiple trailer units that deliver prepared foods for one or more customers. The inventory management system is a computer networked system that operably communicates with the trailer management system and the food preparation system. The inventory management system measures the consumables that are depleted on a per trailer basis and both plans the restocking and delivery of that inventory. It is contemplated that self-driving cars may restock parts of the system. The food preparation system comprises at least a food product that is stored within one or more freezers or storage mechanisms. It is thought that there is a demand-based algorithm that evaluates the need for pre-prepared foods based on interaction with the user interface system.

### CROSS REFERENCE TO RELATED APPLICATIONS

Not applicable.

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of distributed systems. More specifically, it is in the field of distributed food management systems. And yet more specifically, it is in the field of automated food preparation systems

### DESCRIPTION OF RELATED ART

People can go to fast food restaurants or grocery stores to pick up food for themselves. While fast food is a convenient mechanism to deliver pre-prepared meals to people, the real estate, staffing, and management overhead is often quite expensive and prevents the efficient delivery of pre-prepared food to people.

### GENERAL SUMMARY OF THE INVENTION

This is an automatic food preparation system comprised of four subsystems: (1) a trailer management system, (2) an inventory management system, (3) a food preparation system, and (4) a user interface system for ordering pre-prepared foods. The trailer management system is a networked computer system that allows the management of multiple trailer units that deliver prepared foods for one or more customers. The inventory management system is a computer networked system that operably communicates with the trailer management system and the food preparation system. The inventory management system measures the consumables that are depleted on a per trailer basis and both plans the restocking and delivery of that inventory. It is contemplated that self-driving cars may restock parts of the system. The food preparation system comprises at least a food product that is stored within one or more freezers or storage mechanisms. It is thought that there is a demand-based algorithm that evaluates the need for pre-prepared foods based on interaction with the user interface system.

This allows the delivery of many trailer units over a big space and allows non-human preparation of foods and delivery of foods. Delivery of foods may be done by self-driving cars. It allows users a wide variety of very close locations and immediate use for procuring food.

### DESCRIPTION OF FIGURES

FIG. 1 is a perspective view, which shows an exemplary hardware architecture of a computing device used in an embodiment of the invention.

FIG. 2 is a perspective view, which shows an exemplary logical architecture for a client device, according to an embodiment of the invention.

FIG. 3 is a perspective view, which shows an exemplary architectural arrangement of clients, servers, and external services, according to an embodiment of the invention.

FIG. 4 is a perspective view, which shows an embodiment of a hardware architecture of a computing device connected to a network used in various embodiments of the invention.

FIG. 5 is a perspective view, which shows system diagram of the overall layout of the food distribution system.

FIG. 6 is a perspective view, which shows system diagram view of the food product input system.

FIG. 7 is a perspective view, which shows system diagram of the food facility design system.

FIG. 8 is a perspective view, which shows system diagram of the food facility inventory system.

FIG. 9 is a perspective view, which shows system diagram of the food ordering system.

FIG. 10 is a perspective view, which shows system diagram of the demand detector system.

FIG. 11 is a perspective view, which shows system diagram of the visual demand detection system.

FIG. 12 is a perspective view, which shows system diagram of the food facility system.

FIG. 13 is a perspective view, which shows system diagram of a food facility.

FIG. 14 is a perspective view, which shows system diagram of food facility data.

FIG. 15 is a diagram of overall use of the system.

FIG. 16 is a diagram of entering products into the food product input system.

FIG. 17 is a diagram of designing a food facility.

FIG. 18 is a diagram of setting inventory parameters for a food facility.

FIG. 19 is a diagram of stocking a food facility.

FIG. 20 is a diagram of stocking inventory via automated car.

FIG. 21 is a diagram of stocking inventory manually.

FIG. 22 is a diagram of setting parameters for facility demand.

FIG. 23 is a diagram of visual detection demand system is used to detect real time demand.

FIG. 24 is a diagram of pre-preparation of food is done using the food facility system.

FIG. 25 is a diagram of ordering food through a computing device.

FIG. 26 is a diagram of placing an order on an order interface.

FIG. 27 is a diagram of determining location via a mobile device.

FIG. 28 is a diagram of placing order at facility.

FIG. 29 is a diagram of scheduling order pickup at a future date.

FIG. 30 is a diagram of predicting the availability of an order.

FIG. 31 is a diagram of implementation of cooking from precooking apparatus.

FIG. 32 is a diagram of preparing the product for the food cooking system.

FIG. 33 is a diagram of order is picked up by vehicle.

FIG. 34 is a diagram of order is picked up at a High Low Pick Up window.

FIG. 35 is a diagram of order is picked up at a walkup window.

FIG. 36 is a diagram of order is delivered via a drone.

FIG. 37 is a diagram of order is picked up by a delivery service.

FIG. 38 is a diagram of order is delivered by a self driving car.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

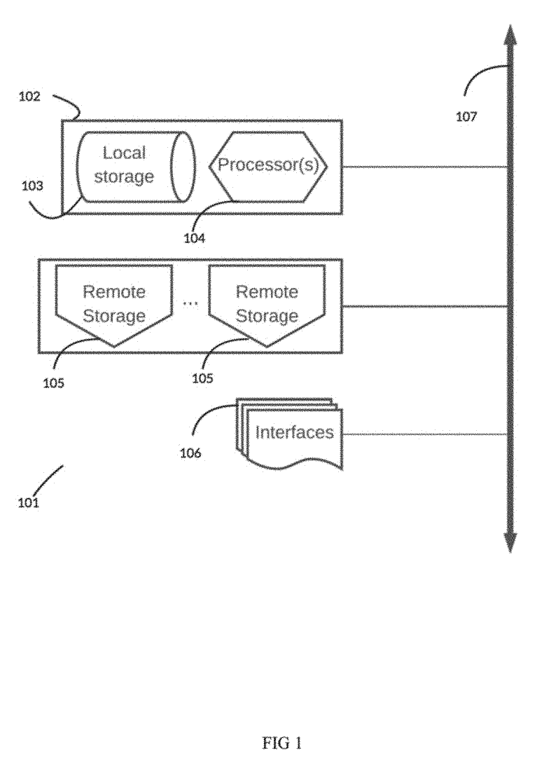

Referring now to FIG. 1, which shows an exemplary hardware architecture of a computing device used in an embodiment of the invention. Computing device 101 comprises an electronic device capable of executing software- or hardware-based instructions according to one or more programs stored in memory. In some embodiments, it is thought that examples of computing device 101 may include: desktop computers, carputers, game consoles, laptops, notebooks, palmtop, tablet, smartphones, smartbooks, or a server system utilizing CPU 102, local memory 103 and/or remote memory 105, and interface 106.

CPU 102 comprises a unit responsible for implementing specific functions associated with the functions of specifically configured computing device or machine. The central processing unit is an acronym which stands for CPU 102. In some embodiments, it is thought that examples of CPU 102 may include: system-on-a-chip (SOC) type hardware, Qualcomm SNAPDRAGON™, or Samsung EXYNOS™ CPU.

Local memory 103 comprises one or more physical devices used to store programs (sequences of instructions) or data (e g. program state information) on a temporary or permanent basis for use in a computer or other digital electronic device, which may be configured to couple to the system in many different configurations. In some embodiments, it is thought that examples of local memory 103 may include: non-volatile random access memory (RAM), read-only memory (ROM), or one or more levels of cached memory.

Processor 104 comprises a component that performs the instructions and tasks involved in computer processing. In some embodiments, it is thought that examples of processor 104 may include: an Intel processor, a ARM processor, a Qualcomm processor, a AMD processor, application-specific integrated circuits (ASICs), electrically erasable programmable read-only memories (EEPROMs), field-programmable gate arrays (FPGAs), a mobile processor, a microprocessor, a microcontroller, a microcomputer, a programmable logic controller, or a programmable circuit. Remote memory 105 comprises a service that provides users with a system for the backup, storage, and recovery of data.

Interface 106 comprises a mechanism to control the sending and receiving of data packets over a computer network or support peripherals used with the computing device 101. In some embodiments, it is thought that examples of interface 106 may include: network interface cards (NICs), ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTH™ interfaces, near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, a high-definition multimedia interface (HDMI), a digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs).

Communications network 107 comprises a communications network that allows computers to exchange data using known protocols. In some embodiments, it is thought that examples of communications network 107 may include: a personal area network, a wireless personal area network, a near-me area network, a local area network, a wireless local area network, a wireless mesh network, a wireless metropolitan area network, a wireless wide area network, a cellular network, a home area network, a storage area network, a campus area network, a backbone area network, a metropolitan area network, a wide area network, an enterprise private network, a virtual private network, an intranet, an extranet, an Internetwork, an Internet, near field communications, a mobile telephone network, a CDMA network, GSM cellular networks, or a WiFi network.

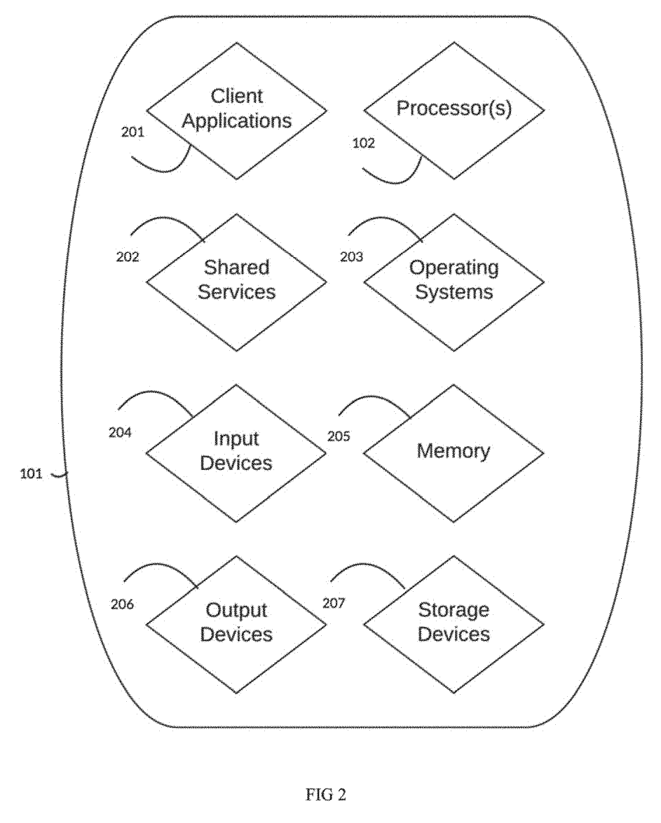

Referring now to FIG. 2, which shows an exemplary logical architecture for a client device, according to an embodiment of the invention. Client application 201 comprises a computing device 101 capable of obtaining information and applications from a server. Shared service 202 comprises web-enabled services or functionality related to a computing device 101.

Operating systems 203 comprises system software that manages computer hardware and software resources and provides common services for computer programs. In some embodiments, it is thought that examples of operating systems 203 may include: Microsoft's WINDOWS™, Apple's Mac OS/X, iOS operating systems, Linux operating system, or Google's ANDROID™ operating system.

Input devices 204 comprises device of any type suitable for receiving user input. In some embodiments, it is thought that examples of input devices 204 may include: a keyboard, a touchscreen, a microphone, a mouse, a touchpad, or a trackball. Memory 205 comprises a mechanism designed to store program instructions, state information, and the like for performing various operations described herein, and may be storage devices 207, in some embodiments. In some embodiments, it is thought that examples of memory 205 may include: read-only memory (ROM), read-only memory (ROM) devices, memristor memory, random access memory (RAM), or RAM hardware modules.

Output devices 206 comprises device of any type suitable for outputting computing device 101 related information. In some embodiments, it is thought that examples of output devices 206 may include: screens for visual output, speakers, or printers. Storage devices 207 comprises a mechanism designed to store information which in some embodiments may be memory 205. In some embodiments, it is thought that examples of storage devices 207 may include: magnetic media, hard disks, floppy disks, magnetic tape, optical media, CD-ROM disks, magneto-optical media, optical disks, flash memory, solid state drives (SSD), “hybrid SSD” storage drives, swappable flash memory modules, thumb drives, removable optical storage discs, or an electrical storage device.

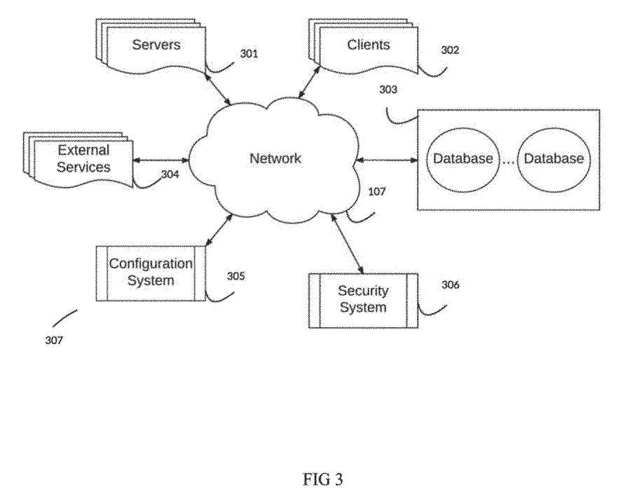

Referring now to FIG. 3, which shows an exemplary architectural arrangement of clients, servers, and external services, according to an embodiment of the invention. Server 301 comprises a computing device 101 configured to handle requests received from one or more client 302 over a communications network 107. Client 302 comprises one or more computing device 101 with program instructions for implementing client-side portions of the present system which in some embodiments, may be connected to a communications network 107.

Database 303 comprises an organized collection of data within a program instructions related system, designed to allow the definition, creation, querying, update, and administration of databases. In some embodiments, it is thought that examples of database 303 may include: a relational database system, a NoSQL system, a Hadoop system, a Cassandra system, a Google BigTable, column-oriented databases, in-memory databases, or clustered databases. External service 304 comprises web-enabled services or functionality related to or installed on a computing device 101 itself which may be deployed on one or more of a particular enterprise's or user's premises. Configuration system 305 comprises a system common to information technology (IT) and web functions that implements configurations or management system. Security system 306 comprises a system common to information technology (IT) and web functions that implements security related functions for the system. Distributed computing network 307 comprises any number of Client and/or Server operably connected to a communications network 107 for the purposes of implementing the system.

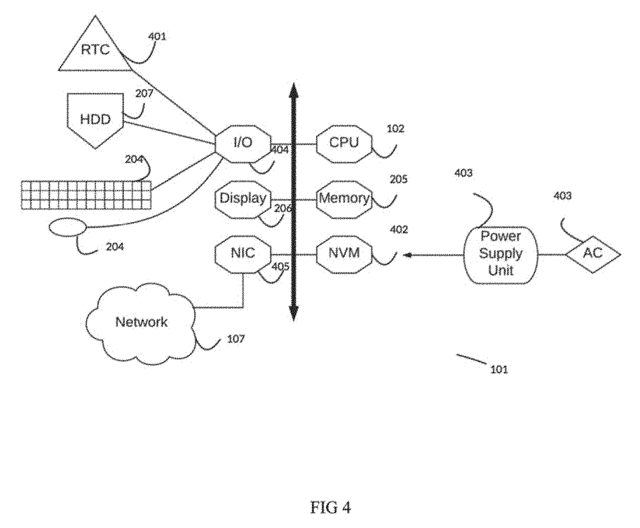

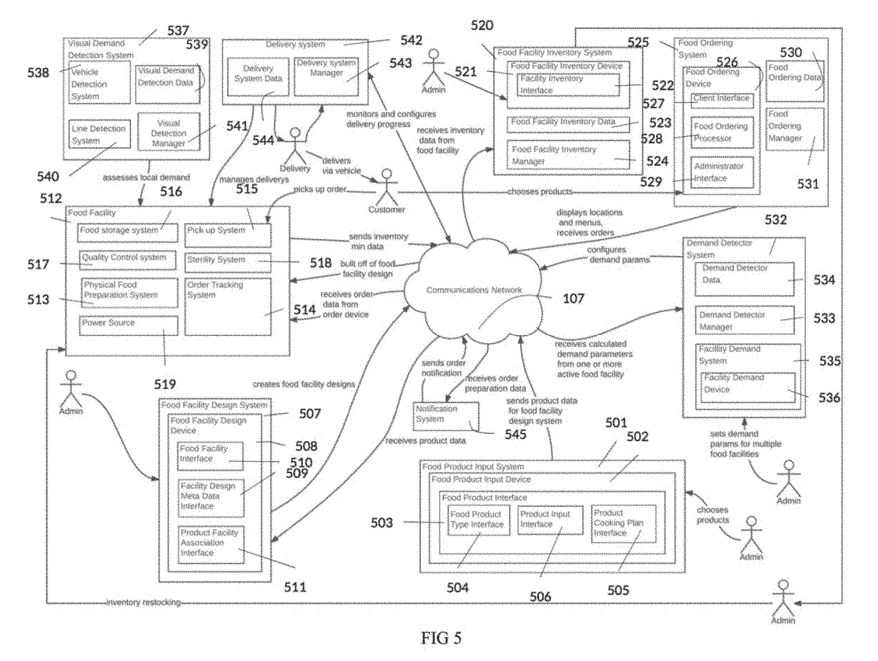

Referring now to FIG. 4, which shows an embodiment of a hardware architecture of a computing device connected to a network used in various embodiments of the invention. Real time clock 401 comprises a computing device 101 clock (most often in the form of an integrated circuit) that keeps track of the current time. Non volatile memory 402 comprises computer memory that can retrieve stored information even after having been power cycled (turned off and back on). Power supply 403 comprises an electronic device that supplies electric energy to an electrical load. Input output units 404 comprises devices used by a human (or other system) to communicate with a computer. NIC 405 comprises a computer hardware component that connects a computer to a computer network.

Referring now to FIG. 5, which shows system diagram of the overall layout of the food distribution system. Food product input system 501 comprises a system that allows the input of one or more products into the food distribution system. One goal of food product input system 501 is to allow the system to be configured around the types of food that are to be sold. For example, if Pizzas, hot dogs, and sushi are product data, then downstream systems such as food facility inventory system 520 and food facility 512 must be designed to accommodate the specific configuration of one or more product 1337. Food product input system 501 preferably comprises food product input device 502, food product input object 605, and finally, food product manager 603.

Food product input device 502 comprises a computing device 101 that accepts data configured for a food product input object 605. One goal of food product input device 502 is to allow an operator of the system to input one or more food types as food product input object 605 such that the different food types can be used by the system. For example, a user may enter Pizza data on the food product input device 502. Food product input device 502 comprises food product interface 503 and food product input processor 604.

Food product interface 503 comprises a graphical user interface that accepts food product input object 605. One goal of food product interface 503 is to allow one or more users to configure the types of food that can be used by the food distribution system. For example, pizza, sausages, sushi, and burgers may be input into the system such that different food facility 512 may be able to provide food for the customers. Food product interface 503 preferably comprises food product type interface 504, product input interface 506, and finally, product cooking plan interface 505.

Food product type interface 504 comprises a graphical user interface that receives food product type object 609. One goal of food product type interface 504 is to allow the designation of the type of food product. For example, meats may be a specific type, the cooking methodology may be a specific type, and storage parameters may be a different type, which can be grouped as similar food requirements for cooking. Product cooking plan interface 505 comprises a graphical user interface that receives product cooking plan object 610. One goal of product cooking plan interface 505 is to allow one or more users to input the data that determines the plan for cooking the product, for example, the duration, temperature, instruments, and requirements for cooking a Pizza. Product input interface 506 comprises a graphical user interface that allows a specific product to be input into the food distribution system. One goal of product input interface 506 is to allow one or more administrators the ability to input a specific product. For example, a product may be sushi, pizza, hamburger, or BBQ sandwich. Product input interface 506 comprises expiry time interface 602 and preparation time interface 601.

Food facility design system 507 comprises a system as part of a distributed computing network 307 that is used to configure the design of a food facility 512 based on the selection of one or more products that have been input via the food product input system 501. One goal of food facility design system 507 is to allow one or more users to select one or more food products in various combinations as a means to predict the food facility 512 design requirements. For example, a user may select burgers and pizza for one food facility 512 and burgers and sushi for another food facility 512 and the system would determine the necessary components for each food facility 512. Food facility design system 507 preferably comprises food facility design device 508.

Food facility design device 508 comprises a computing device 101 that is interacted with by a user in order to configure data for the food facility design system 507. Food facility design device 508 preferably comprises facility design interface 510, facility design metadata interface 509, product facility association interface 511, and finally, facility design object 701. Facility design metadata interface 509 comprises a graphical user interface that receives facility design metadata. One goal of facility design metadata interface 509 is to allow a user to add metadata to one or more food facility 512, such as, location, customers, or preferred tastes within a geographic area. Facility design interface 510 comprises a graphical user interface that receives one or more facility design object 701. One goal of facility design interface 510 is to allow an end user to interact with a computing device 101 to input facility design object 701, for example, selecting one or more products as being designated for a particular food facility 512. Product facility association interface 511 comprises a graphical user interface that receives product facility association object 812. One goal of product facility association interface 511 is to allow a user to specifically relate one or more products to a food facility 512 through a unique identifier. For example, a foreign key in a database may be used to associate food products and a facility.

Food facility 512 comprises a physical location that houses the products and cooking instruments for preparation for a customer. Food facility 512 has an alternative embodiment herein termed “modular food facility”. Food facility 512 preferably comprises food storage system 516, physical food preparation system 513, quality control system 517, order tracking system 514, pick up system 515, power source 519, sterility system 518, and finally, product 1337.

Physical food preparation system 513 comprises one or more cooking instruments that are used to prepare one or more products, for example, 512 512. Physical food preparation system 513 preferably comprises food cooking system 1301, precooking apparatus 1304, food mobility system 1306, ancillary items preparation system 1302, and finally, main cooking apparatus 1336. Order tracking system 514 comprises a part of the food facility 512 that may be integrated into the distributed computing network 307 that tracks an individual order from a customer through the process from ordering to collection. Order tracking system 514 comprises food processing system 1312 and geofencing prompting interface 1328. Pick up system 515 comprises a system as part of the food facility 512 designed to hand off the order to one or more customers. Pick up system 515 preferably comprises walk up window 1309, vehicle pick up system 1310, walk in conveyor 1333, product stalls 1330, order validation ticket 1331, order scanner 1332, product tray 1334, revolving door system 1335, and finally, product delivery waiting area. Food storage system 516 comprises one or more instruments used to accept the food products from an inventory update and store the food products prior to pre-cooking. Food storage system 516 preferably comprises storage freezer 1307. Quality control system 517 comprises a system used for monitoring the quality of one or more food products during an order, such that data can be extracted post-preparation for evaluation of quality prior to delivery to a customer. Quality control system 517 preferably comprises picture taker 1308. Sterility system 518 comprises a system in a food facility 512 that evaluates and manages the sterility of the environment so that it can be in accordance with health or food regulations. Power source 519 comprises a means for powering the food facility 512, for example, batteries, gas electrical, solar etc.

Food facility inventory system 520 comprises part of a distributed computing network 307 that is responsible for managing inventory for one or more food facility 512 to ensure that inventory can be updated. Food facility inventory system 520 preferably comprises food facility inventory device 521, food facility inventory manager 524, and finally, food facility inventory object 523. Food facility inventory device 521 comprises a computing device 101 that receives inventory data and allows one or more food facility 512 to be designated with specific inventory data to be managed as separate units. Food facility inventory device 521 preferably comprises facility inventory interface 522, facility inventory processor 804, and finally, product inventory processor 803.

Facility inventory interface 522 comprises a graphical user interface that receives facility inventory object 807. One goal of facility inventory interface 522 is to allow the management of inventory at a food facility on a per facility basis. For example, a specific food facility 512 located near the highway has specific inventory parameters that allow it to be refilled by trucks on a highway rather than a more centrally-located food facility that has more restricted access. Facility inventory interface 522 comprises product inventory interface 801 and product assignment interface 805.

Food facility inventory object 523 comprises a data object and/or subdata objects for storing and transmitting data related to managing inventory within a food distribution system. Food facility inventory object 523 preferably comprises facility inventory object 807. Food facility inventory manager 524 comprises one or more modules for communication, processing, or algorithm implementation for managing food inventory for food distribution system.

Food ordering system 525 comprises one or more modules responsible for inputting orders into the food distribution system. Food ordering system 525 preferably comprises food ordering device 526, food ordering object 530, and finally, food ordering manager 531. Food ordering device 526 comprises a computing device 101 used to place an order for the food distribution system. Food ordering device 526 has an alternative embodiment herein termed “facility ordering device”. Food ordering device 526 preferably comprises client interface 527, administrator interface 529, and finally, food ordering processor 528.

Client interface 527 comprises a graphical user interface that receives product order data. Client interface 527 preferably comprises order tracker interface 908, mapping interface 905, GPS interface 907, order interface 901, search interface 903, and finally, user profile interface 906. Food ordering processor 528 comprises one or more modules or submodules for processing food orders that may include functions, transformations, classes, or communications. Administrator interface 529 comprises a graphical user interface that allows configuration of the client interface 527.

Food ordering object 530 comprises a data object and/or subdata objects for storing and transmitting data related to a consumer procurement of food at a food facility 512. Food ordering object 530 preferably comprises order tracker object 912, order object 913, menu object 914, user profile object 911, mapping object 910, search object 904, and finally, location object 915. Food ordering manager 531 comprises one or more modules for processing, algorithm implementation, and communication related to ordering food from a customer. Food ordering manager 531 preferably comprises availability manager 909.

Demand detector system 532 comprises system that evaluates the aggregate demand within a particular time frame for mediating time expectations and/or inventory updates. Demand detector system 532 preferably comprises facility demand system 535, demand detector object 534, and finally, demand detector manager 533. Demand detector manager 533 comprises one or more modules for processing communication or algorithm implementation related to the detection of demand in a food facility 512. Demand detector object 534 comprises a data object and/or subdata objects for storing and transmitting data related to the parameters necessary for determining an instance of demand within a time window at a food facility 512 that can be used for predictions and setting customer expectations. Demand detector object 534 preferably comprises facility demand object 1004. Facility demand system 535 comprises a system that evaluates the aggregate demand within a particular time frame for mediating time expectations and/or inventory updates at a particular facility. Facility demand system 535 preferably comprises facility demand device 536. Facility demand device 536 comprises computing device 101 that allows the configuration of demand parameters associated with a particular facility for mediating time and inventory expectations. Facility demand device 536 preferably comprises facility demand interface 1001.

Visual demand detection system 537 comprises a system that evaluates the physical demand located at a particular food facility 512, for example, a camera that assesses the number of cars or people in line. Visual demand detection system 537 preferably comprises line detection system 540, vehicle detection system 538, visual demand detection object 539, and finally, visual detection manager 541. Vehicle detection system 538 comprises system that evaluates the physical demand located at a particular food facility 512, for example, a camera that assesses the number of cars in line. Visual demand detection object 539 comprises a data object and/or subdata objects for storing and transmitting data related to the management or detection of the visual demand at a food facility 512. Visual demand detection object 539 comprises line detection object 1102 and vehicle detection object 1101. Line detection system 540 comprises a system that evaluates the physical demand located at a particular food facility 512, for example, a camera that assesses the number of people in line. Visual detection manager 541 comprises one or more modules related to the communication, processing, and algorithm implementation for mediating or discovering visual signals and converting them into demand-related data for implementation within the system at a food facility 512.

Delivery system 542 comprises a system that is used for home delivery of a customer order wherein the order is picked up from a food facility 512 and delivered to a different location. Delivery system 542 comprises delivery system object 544 and delivery system manager 543. Delivery system manager 543 comprises one or more modules for processing, communication, or algorithm implementation related to the management of the delivery system. Delivery system object 544 comprises a data object and/or subdata objects for storing and transmitting data related to managing and tracking for deliveries gathered from a food facility 512 and delivered to a customer. Notification system 545 comprises the system that lets customers know that their specific orders are available for pickup.

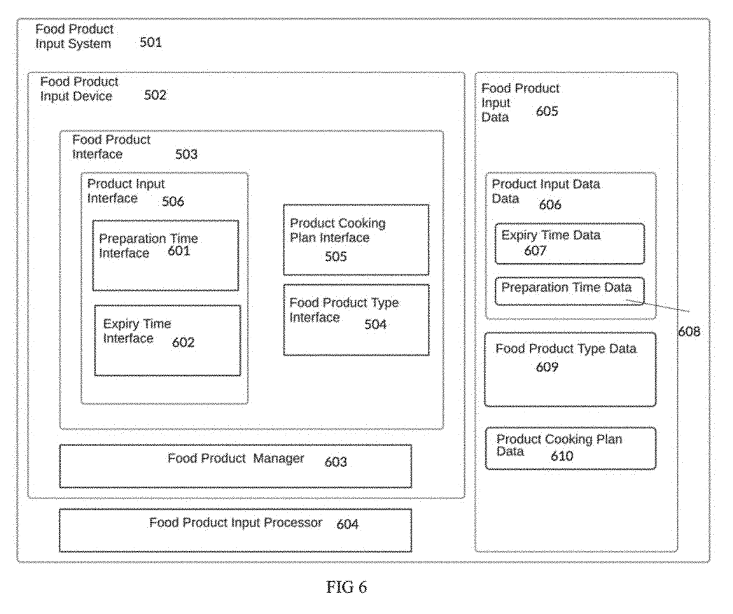

Referring now to FIG. 6, which shows system diagram view of the food product input system. Preparation time interface 601 comprises a graphical user interface that receives preparation time object 608. One goal of preparation time interface 601 is to allow a person to designate one or more times associated with the duration with which it takes the food to be cooked. For example, a Pizza must be in a conveyor oven for 3-5 minutes at a specific temperature. Expiry time interface 602 comprises a graphical user interface that receives expiry time data. One goal of expiry time interface 602 is to allow one or more users to designate the expiration time within which one or more products would no longer be useable.

Food product manager 603 comprises one or more modules for managing, processing, and algorithm implementation related to food products that are globally assigned within a food distribution system. Food product input processor 604 comprises one or more modules or submodules for processing food product input object 605 that may include functions, transformations, classes, or communications.

Food product input object 605 comprises a data object and/or subdata objects for storing and transmitting data related to foods or products to be sold at one or more food facility 512 within a food distribution system. Food product input object 605 preferably comprises food product type object 609, product cooking plan object 610, and finally, product input object 606. Product input object 606 comprises a data object and/or subdata objects for storing and transmitting data related to the input of products into the food distribution system. Product input object 606 comprises expiry time object 607 and preparation time object 608. Expiry time object 607 comprises a data object and/or subdata objects for storing and transmitting data related to the expiration date of a product from being saleable to a customer once cooked. Preparation time object 608 comprises a data object and/or subdata objects for storing and transmitting data related to the time it takes to cook a particular food product.

Food product type object 609 comprises a data object and/or subdata objects for storing and transmitting data related to the categorization of food products as being related to one another, for example, taxonomical categories such as meat, vegetables, and toppings, as parent categories or tags for particular products. Product cooking plan object 610 comprises a data object and/or subdata objects for storing and transmitting data related to the metadata necessary for the sequential cooking plan for a particular product, for example, cooking timing, temperature, instruments, expiration dates, and other cooking parameters.

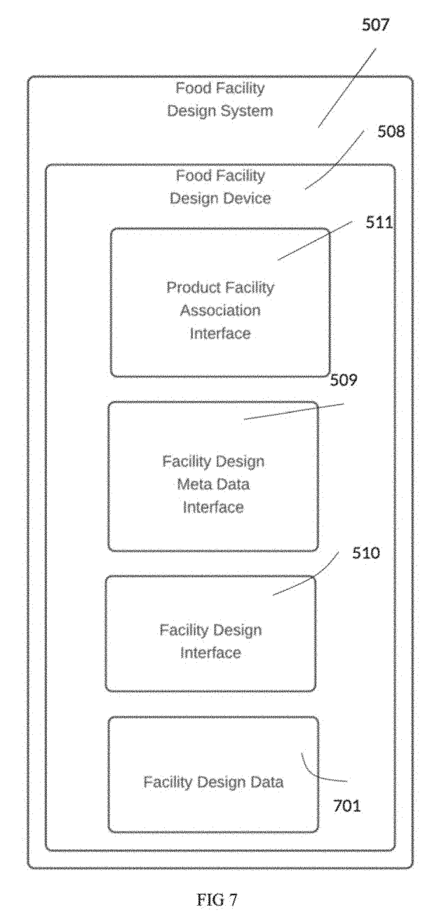

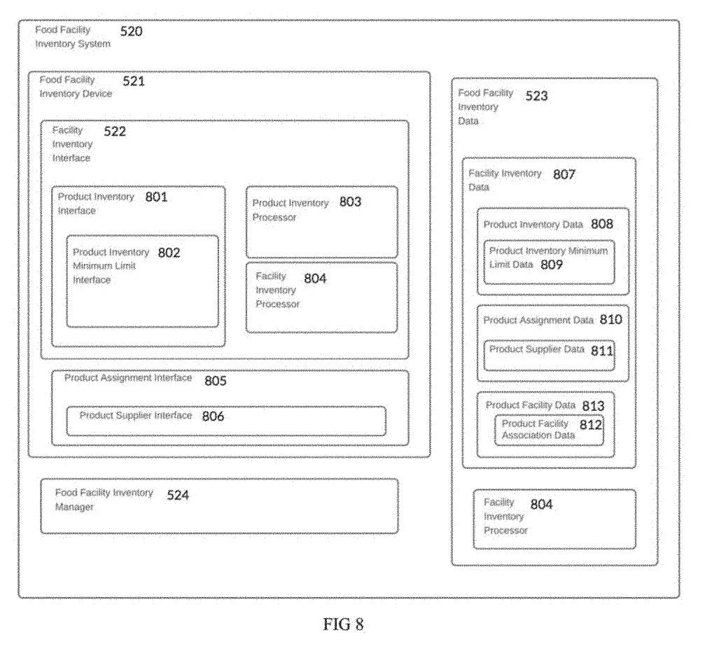

Referring now to FIG. 7, which shows system diagram of the food facility design system. Facility design object 701 comprises data or data objects that configure the parameters of a food facility 512 based on one or more product 1337.

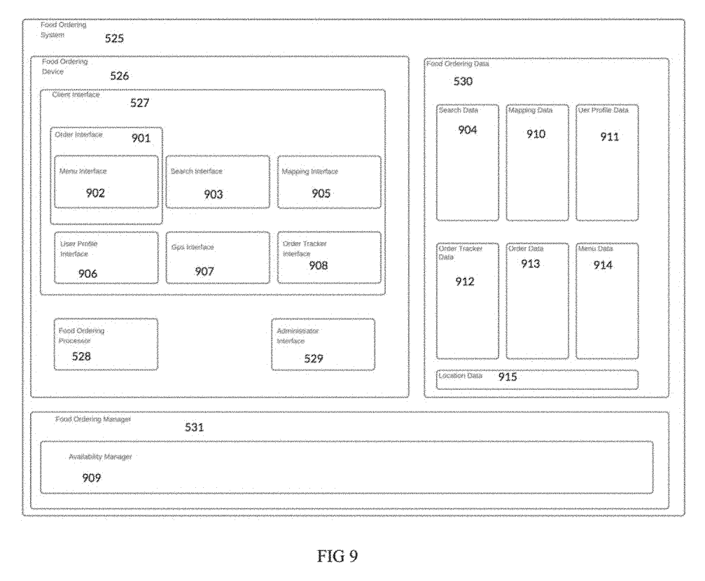

Referring now to FIG. 8, which shows system diagram of the food facility inventory system. Product inventory interface 801 comprises a graphical user interface that allows the management of specific products within the food facility 512 and receives product inventory object 808. One goal of product inventory interface 801 is to allow the configuration of product inventory object 808 and the means by which the inventory is managed on a per facility basis. For example, pizza may be managed by one inventory protocol whereas burgers may be managed by another inventory protocol within the same food facility 512. Product inventory interface 801 preferably comprises product inventory minimum limit interface 802. Product inventory minimum limit interface 802 comprises a graphical user interface that receives product inventory minimum limit object 809. One goal of product inventory minimum limit interface 802 is to allow one or more users to configure the minimum quantity of a food product before an event is triggered, to replenish the food items at a particular food facility 512.

Product inventory processor 803 comprises one or more modules configured to relay or process product inventory object 808 for communication on the distributed computing network 307. Facility inventory processor 804 comprises one or more modules configured to relay or process facility inventory object 807 for communication on the distributed computing network 307.

Product assignment interface 805 comprises a graphical user interface that receives product assignment object 810. One goal of product assignment interface 805 is to allow the assignment of a product 1337 as being produced at a specific food facility 512. Product assignment interface 805 preferably comprises product supplier interface 806. Product supplier interface 806 comprises a graphical user interface that receives the product supplier object 811. One goal of product supplier interface 806 is to allow the assignment of one or more product assignment object 810 to be restocked by one or more product suppliers as reflected by product supplier object 811.

Facility inventory object 807 comprises a data object and/or subdata objects for storing and transmitting data related to inventory at a particular food facility 512. Facility inventory object 807 preferably comprises product inventory object 808, product facility object 813, and finally, product assignment object 810. Product inventory object 808 comprises a data object and/or subdata objects for storing and transmitting data related to a particular product's inventory at a food facility 512. Product inventory object 808 preferably comprises product inventory minimum limit object 809. Product inventory minimum limit object 809 comprises a data object and/or subdata objects for storing and transmitting data related to the setting of a minimum count inventory available for a particular product before the triggering of an event related to the restocking of the product at the food facility 512. Product assignment object 810 comprises data or data objects for configuring a product to a food facility 512. Product assignment object 810 preferably comprises product supplier object 811. Product supplier object 811 comprises data or data objects for configuring a supplier of a product 1337 at a particular food facility 512. Product facility object 813 comprises data or data objects that capture all of the existing product 1337 for a food facility 512. Product facility object 813 preferably comprises product facility association object 812. Product facility association object 812 comprises data or data objects that configure all of the product 1337 as being associated with a particular food facility 512.

Referring now to FIG. 9, which shows system diagram of the food ordering system. Order interface 901 comprises a graphical user interface that allows a customer to place an order. Order interface 901 preferably comprises menu interface 902. Menu interface 902 comprises a graphical user interface that allows a customer to view a menu for one or more food facility 512. Search interface 903 comprises a graphical user interface that allows an end user to search for one or more food facility 512 and the products and timing within which an order may be delivered.

Search object 904 comprises one or more data objects that contain keywords, strings, or audio content that reflect the user's desire to search for information within the food distribution system. Mapping interface 905 comprises a graphical user interface that displays maps of food facility 512 as related to the location of a customer. User profile interface 906 comprises a graphical user interface that presents, stores, or modifies user information. GPS interface 907 comprises a graphical user interface that captures a person's GPS coordinates to determine which food facility 512 are closest. Order tracker interface 908 comprises a graphical user interface that allows an end user to examine the current state of their order within the food distribution system.

Availability manager 909 comprises one or more modules responsible for determining the availability of food products when an order is placed at one or more food facility 512. Mapping object 910 comprises one or more data objects that reflect the geographical locations of one or more food facility 512. User profile object 911 comprises one or more data objects reflecting a subscribed user to the food distribution system. Order tracker object 912 comprises one or more data objects that reflect the order's state of preparation at any particular time within the food distribution system. Order object 913 comprises one or more data objects that reflect an instance order from a particular customer. Menu object 914 comprises one or more data objects that contain the menu data for one or more food facility 512. Location object 915 comprises data or data objects that reflect the specific location of the food facility 512.

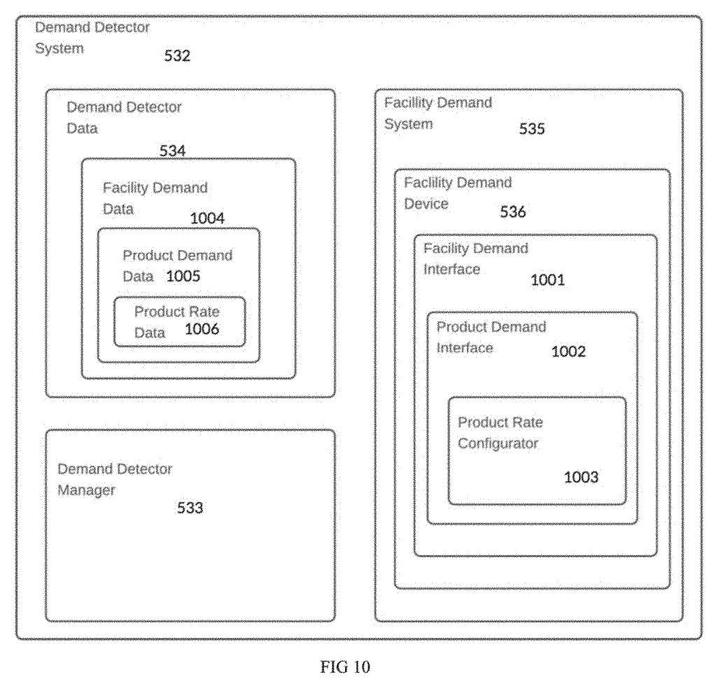

Referring now to FIG. 10, which shows system diagram of the demand detector system. Facility demand interface 1001 comprises a graphical user interface that receives facility demand data. Facility demand interface 1001 preferably comprises product demand interface 1002. Product demand interface 1002 comprises a graphical user interface that receives a particular product demand data. Product demand interface 1002 preferably comprises product rate configurator 1003. Product rate configurator 1003 comprises a graphical user interface that receives particular configuration parameters that are associated with a product consumption rate.

Facility demand object 1004 comprises a data object and/or subdata objects for storing and transmitting data related to demand at a particular food facility 512. Facility demand object 1004 preferably comprises product demand object 1005. Product demand object 1005 comprises a data object and/or subdata objects for storing and transmitting data related to assaying the demand for a particular product at a food facility 512 for managing customer expectations and/or inventory management. Product demand object 1005 preferably comprises product rate object 1006. Product rate object 1006 comprises a data object and/or subdata objects for storing and transmitting data related to the set parameters configured for a particular product as related to the consumption that would trigger one or more events for detecting demand.

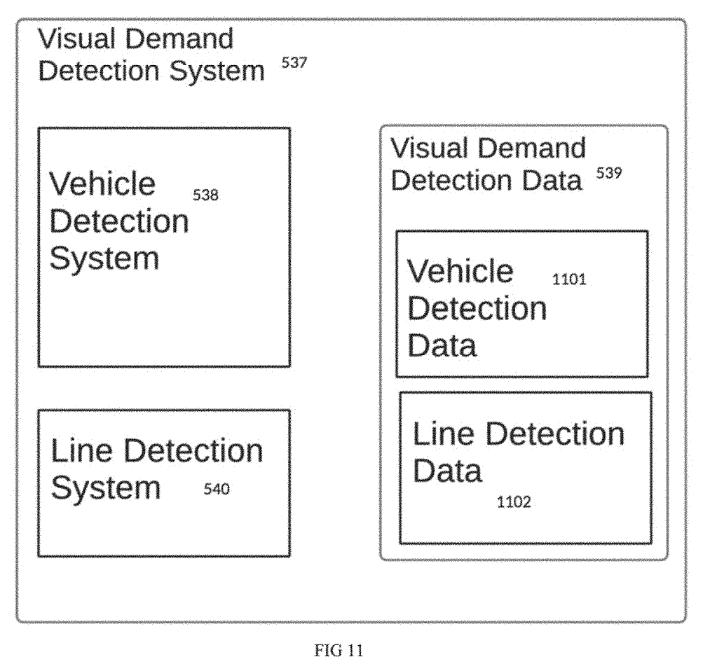

Referring now to FIG. 11, which shows system diagram of the visual demand detection system. Vehicle detection object 1101 comprises a data object and/or subdata objects for storing and transmitting data related to determining how many vehicles are lined up at a food facility 512. Line detection object 1102 comprises a data object and/or subdata objects for storing and transmitting data related to detecting demand related to customers in a line at a food facility 512.

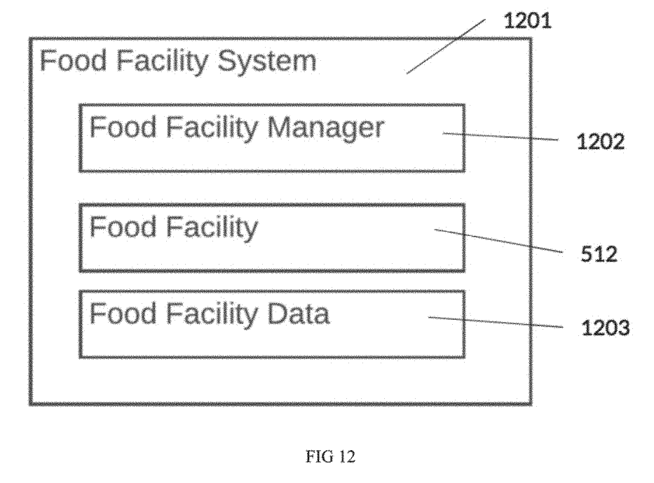

Referring now to FIG. 12, which shows system diagram of the food facility system. Food facility system 1201 comprises a system used to manage the subsystems related to a particular food facility 512, including the physical components and relevant communications and management software systems. Food facility system 1201 preferably comprises food facility 512, food facility object 1203, and finally, food facility manager 1202. Food facility manager 1202 comprises one or more systems containing one or more modules or submodules for processing data related to a particular food facility that may include functions, transformations, classes, or communications. Food facility object 1203 comprises a data object and/or subdata objects for storing and transmitting data related to management and operation of a food facility 512. Food facility object 1203 preferably comprises order tracking object 1401.

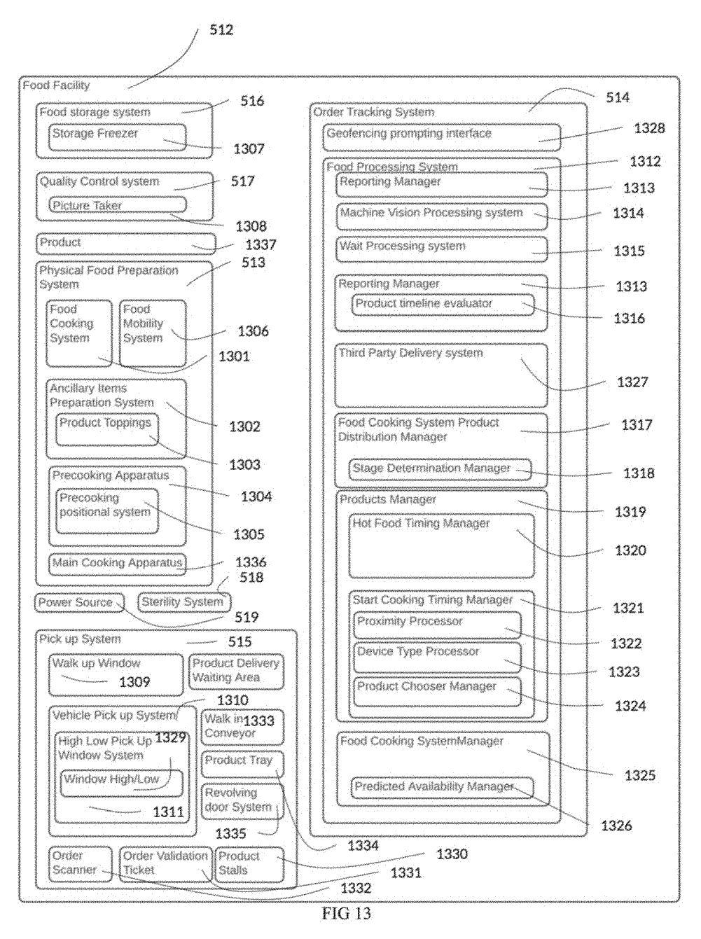

Referring now to FIG. 13, which shows system diagram of a food facility. Food cooking system 1301 comprises a system consisting of one or more means of preparing cooked foods. Ancillary items preparation system 1302 comprises system that adorns one or more food products with relevant ancillary toppings, such as onions, bell peppers, extra cheese, etc. etc. Ancillary items preparation system 1302 preferably comprises product toppings 1303. Product toppings 1303 comprises is one or more ancillary food items on a product that is associated with an order. In some embodiments, it is thought that examples of product toppings 1303 may include: cheese, jalapeno pepper, bell pepper, onions, extra cheese, etc. In some embodiments, it is thought that if product toppings 1303 is absent then a product may be ordered without toppings. Precooking apparatus 1304 comprises one or more cooking instruments that serve to precook one or more food products prior to the actual customer order so that when an order is received, an alternative cooking method may be used to create a proper texture, temperature, while making it readily available. Precooking apparatus 1304 has multiple alternative embodiments herein termed embodiment, embodiment, and “off site pre-cooking” embodiment. Precooking apparatus 1304 preferably comprises precooking positional system 1305. Precooking positional system 1305 comprises system that would allow the determination of the position of one or more food products inside a precooking apparatus 1304 for identification and association with a particular order. In some embodiments, it is thought that if precooking positional system 1305 is absent then a mechanical tracking system or visual system may suffice.

Food mobility system 1306 comprises system for mechanically moving different food products through a food facility 512, which may vary dependent upon different stages or products relative to the cooking instruments used to prepare them. Food mobility system 1306 has an alternative embodiment herein termed “robotic arm mobility system” embodiment and another termed “conveyor mobility system” embodiment.

Storage freezer 1307 comprises one or more instruments used to accept the food products from an inventory update and store the food products at or below freezing temperatures prior to pre-cooking. Picture taker 1308 comprises a means for capturing photos of food during the ordering process that can be particularly associated with an order and shown to an end user or administrator as reflective of the quality of the food preparation.

Walk up window 1309 comprises a window where the order is placed for a customer that is not configured for a vehicle. Vehicle pick up system 1310 comprises a window or system for a customer to pick up an order that is specifically configured for drive up service in a car. Vehicle pick up system 1310 preferably comprises high low pick up window system 1311. High low pick up window system 1311 comprises a system that is used to change the height of the pickup window depending on the height of the vehicle. High low pick up window system 1311 preferably comprises window high low 1329.

Food processing system 1312 comprises the system that manages a particular food as part of an order in terms of tracking and management during preparation. One goal of food processing system 1312 is to allow the tracking of an individual food item as associated with a food order; for example, a food processing system may manage the pizza as an aspect of a burger pizza order. Food processing system 1312 preferably comprises food cooking system manager 1325, machine vision processing system 1314, reporting manager 1313, wait processing system 1315, third party delivery processing system 1327, food cooking system product distribution manager 1317, and finally, products manager 1319.

Reporting manager 1313 comprises a module or some modules that are able to manage the data processing and/or communication of the status of an order at each relevant stage of preparation. Reporting manager 1313 preferably comprises product timeline evaluator 1316. Machine vision processing system 1314 comprises a system that uses machine learning to recognize one or more products as being associated with a particular order, stage, or part of cooking preparation. Wait processing system 1315 comprises system that allows the determination of the wait time as collated with other orders and the items within an individual order that can be output to a customer to set expectations for delivery of the order. Product timeline evaluator 1316 comprises output data that allows the monitoring of a food order and gives reports on the various stages during its preparation. Food cooking system product distribution manager 1317 comprises a module or modules that oversees the duration and time that a product is in a food cooking system as a means to determine the relative preparedness of the product during an order. Food cooking system product distribution manager 1317 preferably comprises stage determination manager 1318.

Stage determination manager 1318 comprises a module or modules that allow the determination of what stage a product is at and what stage of cooking in the physical food preparation system 513 it may be in. Products manager 1319 comprises one or more modules that evaluate the specific timings and instances of cooking for a particular product as associated with an order. Products manager 1319 comprises start cooking timing manager 1321 and hot food timing manager 1320. Hot food timing manager 1320 comprises one or more modules responsible for measuring the times associated with cooking a particular food product. Start cooking timing manager 1321 comprises one or more modules that capture the time within which a product starts to cook. In some embodiments, it is thought that an example of start cooking timing manager 1321 may include GPS and the like. Start cooking timing manager 1321 preferably comprises device type processor 1323, proximity processer 1322, and finally, product chooser manager 1324. Proximity processer 1322 comprises one or more mechanisms by which to manage the starting time of cooking a food product based on the proximity of the user associated with the order. Device type processor 1323 comprises one or more modules that captures the means by which the customer order was placed for calculating relevant start times associated with cooking food in an order. In some embodiments, it is thought that examples of device type processor 1323 may include: walkup, mobile device, or drive in. Product chooser manager 1324 comprises one or more modules that change the start time for cooking a food product based on the global number of food products in the order so that they may be received simultaneously when delivered to the customer.

Food cooking system manager 1325 comprises one or more modules that manage the temperature and configuration of one or more cooking systems for cooking particular products, for example, having multiple conveyors with differing ovens set at different temperatures. Food cooking system manager 1325 preferably comprises predicted availability manager 1326. Predicted availability manager 1326 comprises a module or sub modules that examine the existing demand, products available, and current products available inventory to provide a report on the predicted availability of a product to an end user. Third party delivery processing system 1327 comprises a module of code that interfaces the food distribution system with an outside delivery service. Third party delivery processing system 1327 has an alternative embodiment herein termed “delivery” embodiment. Geofencing prompting interface 1328 comprises a graphical user interface that allows a food facility 512 to be associated with particular boundaries that are presented to one or more customers. One goal of geofencing prompting interface 1328 is to allow a person to be prompted within a certain range of location of food facility 512 for ordering preemptively.

Window high low 1329 comprises an embodiment of the vehicle pick up system 1310 wherein there are two windows, one high and one lower, in order to accommodate vehicle height, and the system may detect vehicle height for placement of the order in either of the windows. Product stalls 1330 comprises the holding areas for prepared foods while they await customer pickup. Order validation ticket 1331 comprises a ticket that provides a scannable code that verifies to the order scanner 1332 the customer's order and that payment was received. Order scanner 1332 comprises an optical device used to scan a customer's order validation ticket 1331 to verify that the order is correct and paid for. Walk in conveyor 1333 comprises a conveyor that delivers one or more finished product 1337 to a customer via a conveyor. Product tray 1334 comprises a moveable where food is placed for conveyance throughout the food facility 512. Revolving door system 1335 comprises an area where food is stored to await final payment from the customer. Upon payment, the revolving door system turns around to expose the food to the customer for pickup. Main cooking apparatus 1336 comprises the cooking apparatus that is used for final searing and/or heating after being removed from the precooking apparatus 1304. Product 1337 comprises one or more food items that are prepared after ordering by a customer at a food facility 512. Examples include Pizzas, burgers, sushi, hotdogs, chicken, fish, French fries, etc.

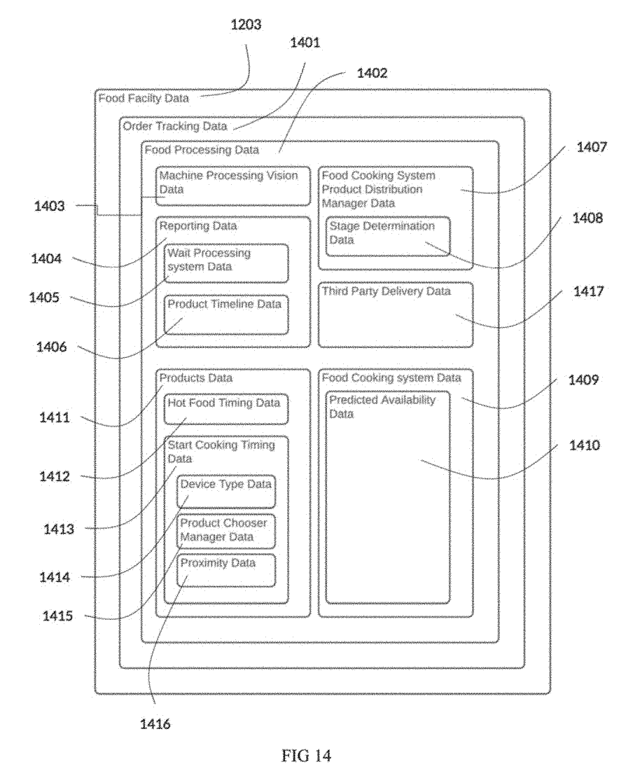

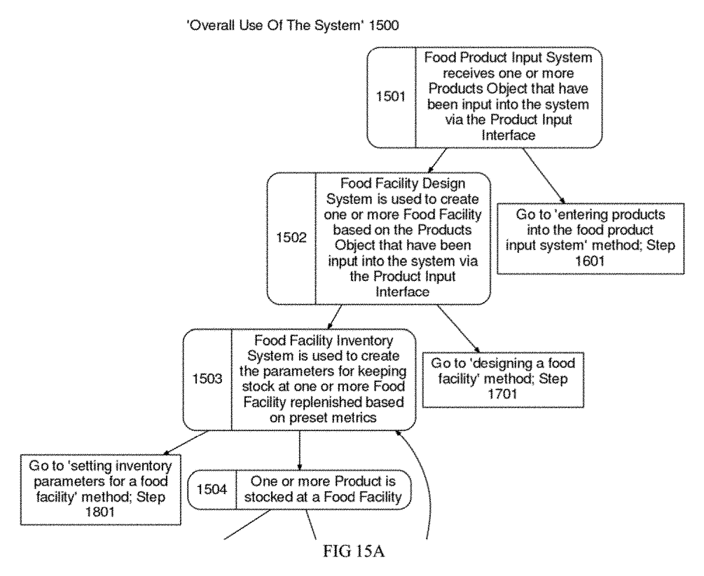

Referring now to FIG. 14, which shows system diagram of food facility data. Order tracking object 1401 comprises a data object and/or subdata objects for storing and transmitting data related to tracking and processing customer orders at a food facility 512. Order tracking object 1401 preferably comprises food processing object 1402. Food processing object 1402 comprises a data object and/or subdata objects for storing and transmitting data related to preparation of foods as related to a customer order. Food processing object 1402 preferably comprises food cooking system object 1409, food cooking system product distribution manager object 1407, third party delivery object 1417, reporting object 1404, machine vision processing object 1403, and finally, products object 1411. Machine vision processing object 1403 comprises a data object and/or subdata objects for storing and transmitting data related to configuration parameters and/or training data or models used for machine learning-based vision recognition. Reporting object 1404 comprises a data object and/or subdata objects for storing and transmitting data related to producing reports for orders for a customer. Reporting object 1404 comprises wait processing system object 1405 and product timeline object 1406. Wait processing system object 1405 comprises a data object and/or subdata objects for storing and transmitting data related to parameters necessary for the algorithms to determine an expected wait time for particular food orders or food products at a particular food facility 512. Product timeline object 1406 comprises a data object and/or subdata objects for storing and transmitting data related to tracking the different stages where a product may be, from ordering through delivery to a customer.

Food cooking system product distribution manager object 1407 comprises a data object and/or subdata objects for storing and transmitting data related to tracking food products during the production or distribution at a food facility. Food cooking system product distribution manager object 1407 preferably comprises stage determination object 1408. Stage determination object 1408 comprises a data object and/or subdata objects for storing and transmitting data related to calculating the stage of preparation for one or more food products at a food facility 512. Food cooking system object 1409 comprises a data object and/or subdata objects for storing and transmitting data related to temperature and cooking parameters for preparation of one or more food products. Food cooking system object 1409 preferably comprises predicted availability object 1410. Predicted availability object 1410 comprises a data object and/or subdata objects for storing and transmitting data related to the predicted availability of one or more product 1337 for a customer.

Products object 1411 comprises a data object and/or subdata objects for storing and transmitting data related to the cooking tracking management of individual products at a food facility 512. Products object 1411 comprises start cooking timing object 1413 and hot food timing object 1412. Hot food timing object 1412 comprises a data object and/or subdata objects for storing and transmitting data related to measuring the times associated with cooking a particular food product. Start cooking timing object 1413 comprises a data object and/or subdata objects for storing and transmitting data related to the time within which a product starts to cook. Start cooking timing object 1413 preferably comprises product chooser manager object 1415, device type object 1414, and finally, proximity object 1416. Device type object 1414 comprises a data object and/or subdata objects for storing and transmitting data related to the means by which the customer order was placed for calculating relevant start times associated with cooking food in an order. Product chooser manager object 1415 comprises a data object and/or subdata objects for storing and transmitting data related to the start time for cooking a food product based on the global number of food products in the order so that they may be received simulataneously when delivered to the customer. Proximity object 1416 comprises a data object and/or subdata objects for storing and transmitting data related to managing the starting time of cooking a food product based on the proximity of the user associated with the order.

Third party delivery object 1417 comprises a data object and/or subdata objects for storing and transmitting data related to interfacing the food distribution system with an outside delivery service.

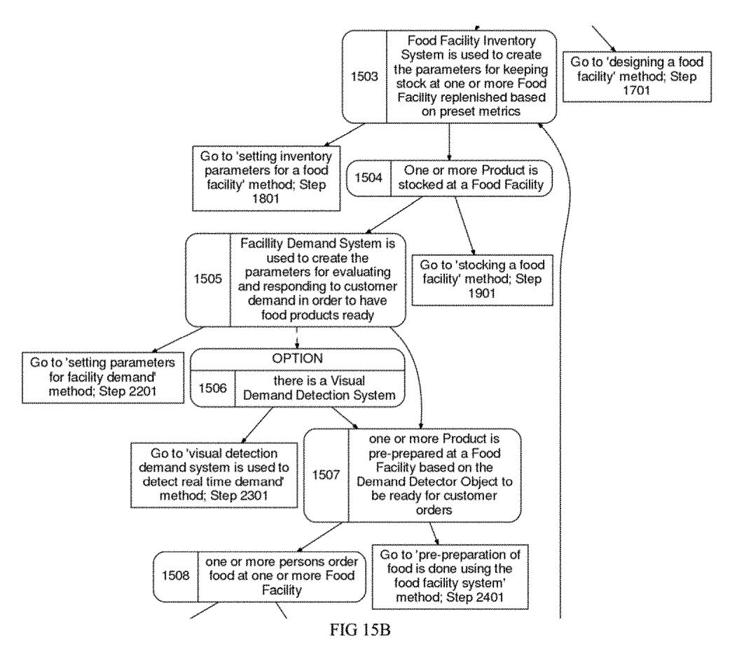

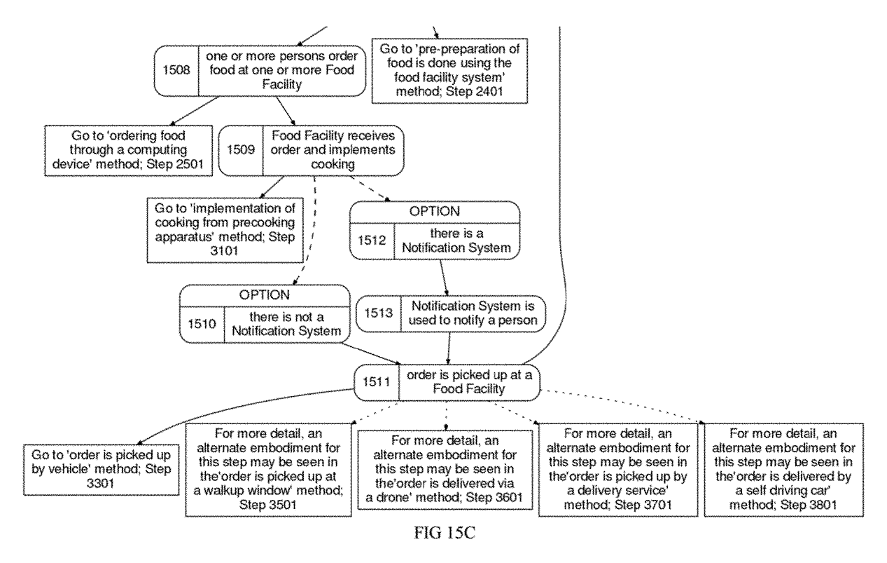

Referring now to FIG. 15, which shows overall use of the system. In a first step, food product input system 501 receives one or more products object 1411 that have been input into the system via the product input interface 506 (Step 1501). Step 1501 is further detailed below in a related method (1600—‘entering products into the food product input system’). Next, food facility design system 507 is used to create one or more food facility 512 based on the products object 1411 that have been input into the system via the product input interface 506 (Step 1502). Step 1502 is further detailed below in a related method (1700—‘designing a food facility’). Next, food facility inventory system 520 is used to create the parameters for keeping stock at one or more food facility 512 replenished based on preset metrics (Step 1503). Step 1503 is further detailed below in a related method (1800—‘setting inventory parameters for a food facility’). Next, One or more product 1337 is stocked at a food facility 512 (Step 1504). Step 1504 is further detailed below in a related method (1900—‘stocking a food facility’).

Next, facility demand system 535 is used to create the parameters for evaluating and responding to customer demand in order to have food products ready (Step 1505). Step 1505 is further detailed below in a related method (2200—‘setting parameters for facility demand’). If there is a visual demand detection system 537 (Step 1506), then Step 1506 is further detailed below in a related method (2300—‘visual detection demand system is used to detect real time demand’). then one or more product 1337 is pre-prepared at a food facility 512 based on the demand detector object 534 to be ready for customer orders (Step 1507). Step 1507 is further detailed below in a related method (2400—‘pre-preparation of food is done using the food facility system’). Next, one or more persons order food at one or more food facility 512 (Step 1508). Step 1508 is further detailed below in a related method (2500—‘ordering food through a computing device’).

Next, food facility 512 receives order and implements cooking (Step 1509). Step 1509 is further detailed below in a related method (3100—‘implementation of cooking from precooking apparatus’). If there is not a notification system 545 (Step 1510), then order is picked up at a food facility 512 (Step 1511). Step 1511 is further detailed below in a related method (3300—‘order is picked up by vehicle’). Next, refer to Step 1503. Step 1503 is further detailed below in a related method (1800—‘setting inventory parameters for a food facility’). From Step 1509, if there is a notification system 545 (Step 1512), then notification system 545 is used to notify a person (Step 1513). Next, refer to Step 1511. Step 1511 is further detailed below in a related method (3300—‘order is picked up by vehicle’). From Step 1505, next, refer to Step 1507. Step 1507 is further detailed below in a related method (2400—‘pre-preparation of food is done using the food facility system’, or off-site location.).

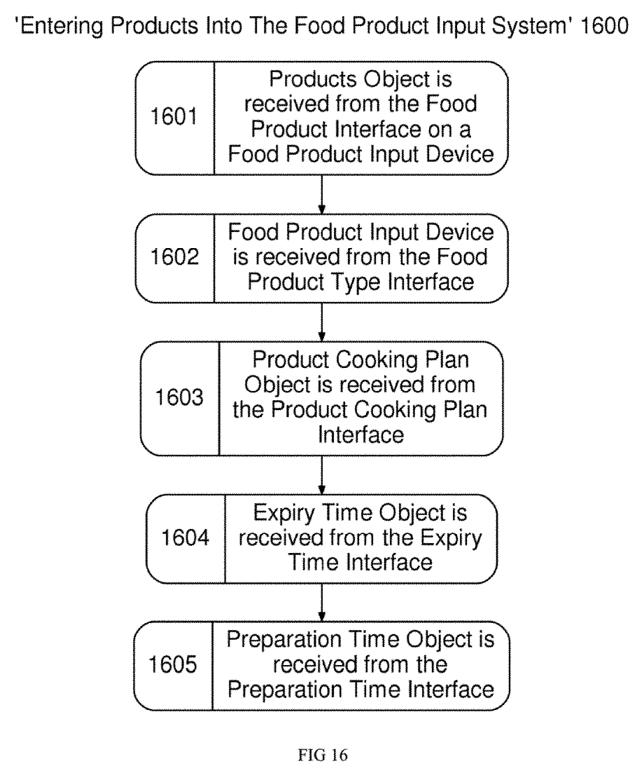

Referring now to FIG. 16, which shows entering products into the food product input system. In a first step, products object 1411 is received from the food product interface 503 on a food product input device 502 (Step 1601). Next, food product input device 502 is received from the food product type interface 504 (Step 1602). Next, product cooking plan object 610 is received from the product cooking plan interface 505 (Step 1603). Next, expiry time object 607 is received from the expiry time interface 602 (Step 1604). Next, preparation time object 608 is received from the preparation time interface 601 (Step 1605).

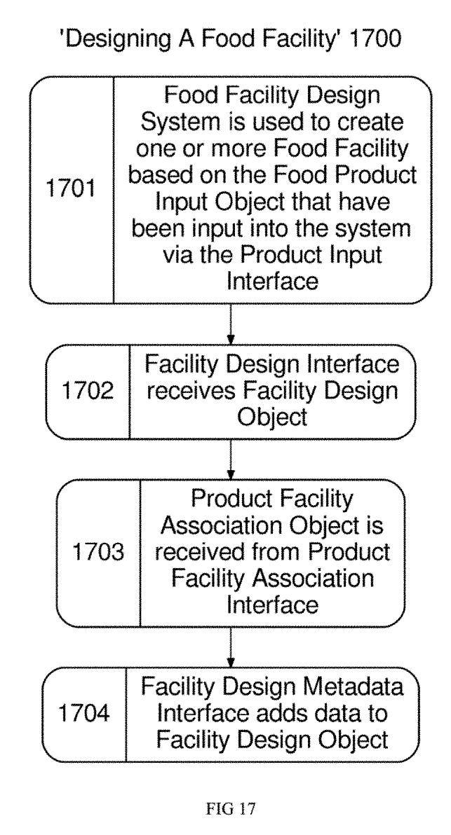

Referring now to FIG. 17, which shows designing a food facility. In a first step, food facility design system 507 is used to create one or more food facility 512 based on the food product input object 605 that have been input into the system via the product input interface 506 (Step 1701). Next, facility design interface 510 receives facility design object 701 (Step 1702). Next, product facility association object 812 is received from product facility association interface 511 (Step 1703). Next, facility design metadata interface 509 adds data to facility design object 701 (Step 1704).

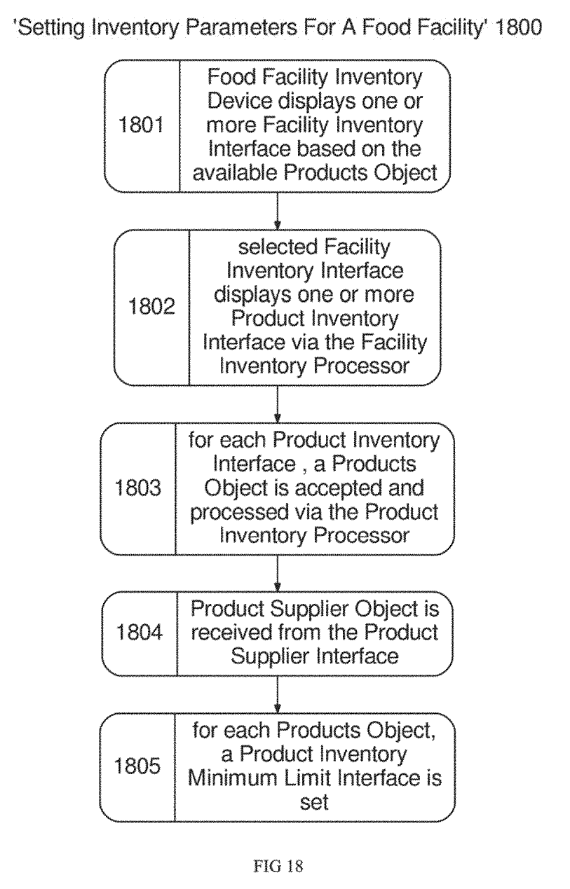

Referring now to FIG. 18, which shows setting inventory parameters for a food facility. In a first step, food facility inventory device 521 displays one or more facility inventory interface 522 based on the available products object 1411 (Step 1801). Next, selected facility inventory interface 522 displays one or more product inventory interface 801 via the facility inventory processor 804 (Step 1802). Next, for each product inventory interface 801, a products object 1411 is accepted and processed via the product inventory processor 803 (Step 1803). Next, product supplier object 811 is received from the product supplier interface 806 (Step 1804). Next, for each products object 1411, a product inventory minimum limit interface 802 is set (Step 1805).

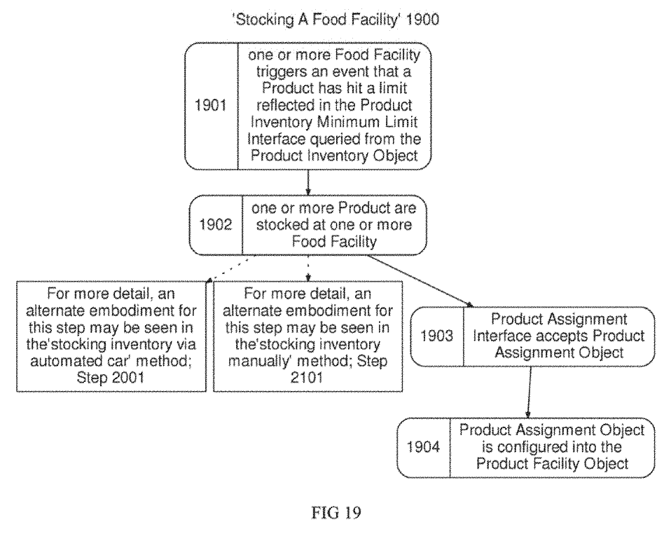

Referring now to FIG. 19, which shows stocking a food facility. In a first step, one or more food facility 512 triggers an event that a product 1337 has hit a limit reflected in the product inventory minimum limit interface 802 queried from the product inventory object 808 (Step 1901). Next, one or more product 1337 are stocked at one or more food facility 512 (Step 1902). In an alternative embodiment, Step 1902 may be performed as in Method (2000—‘stocking inventory via automated car’). Next, product assignment interface 805 accepts product assignment object 810 (Step 1903). Next, product assignment object 810 is configured into the product facility object 813 (Step 1904).

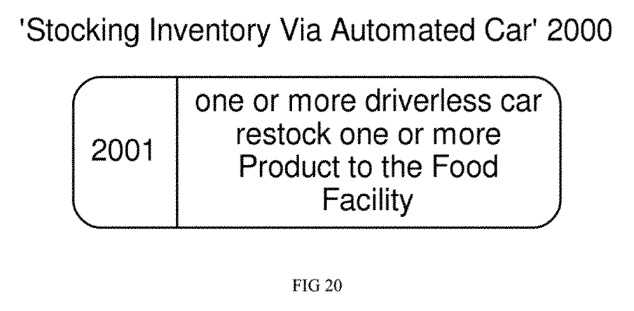

Referring now to FIG. 20, which shows stocking inventory via automated car. In a first step, one or more driverless car restock one or more product 1337 to the food facility 512 (Step 2001).

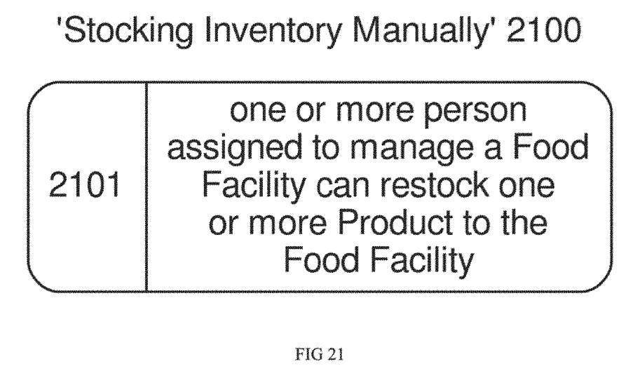

Referring now to FIG. 21, which shows stocking inventory manually. In a first step, one or more person assigned to manage a food facility 512 can restock one or more product 1337 to the food facility 512 (Step 2101).

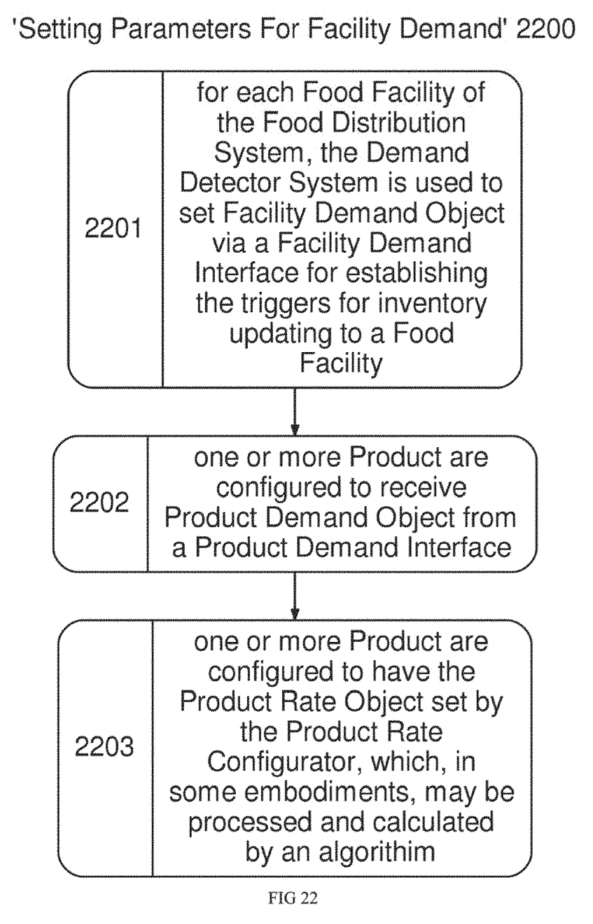

Referring now to FIG. 22, which shows setting parameters for facility demand.

In a first step, for each food facility 512 of the food distribution system, the demand detector system 532 is used to set facility demand object 1004 via a facility demand interface 1001 for establishing the triggers for inventory updating to a food facility 512 (Step 2201). Next, one or more product 1337 are configured to receive product demand object 1005 from a product demand interface 1002 (Step 2202). Next, one or more product 1337 are configured to have the product rate object 1006 set by the product rate configurator 1003, which, in some embodiments, may be processed and calculated by an algorithm (Step 2203).

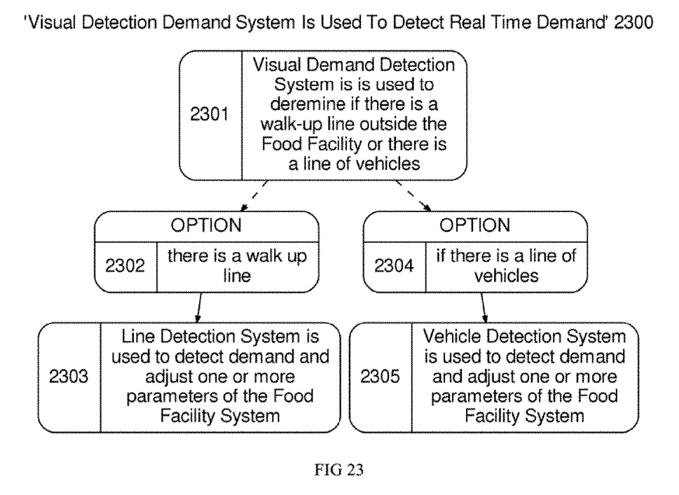

Referring now to FIG. 23, which shows visual detection demand system is used to detect real time demand. In a first step, visual demand detection system 537 is used to determine if there is a walk-up line outside the food facility 512 or there is a line of vehicles (Step 2301). If there is a walk up line (Step 2302), then line detection system 540 is used to detect demand and adjust one or more parameters of the food facility system 1201 (Step 2303). From Step 2301, if there is a line of vehicles (Step 2304), then vehicle detection system 538 is used to detect demand and adjust one or more parameters of the food facility system 1201 (Step 2305).

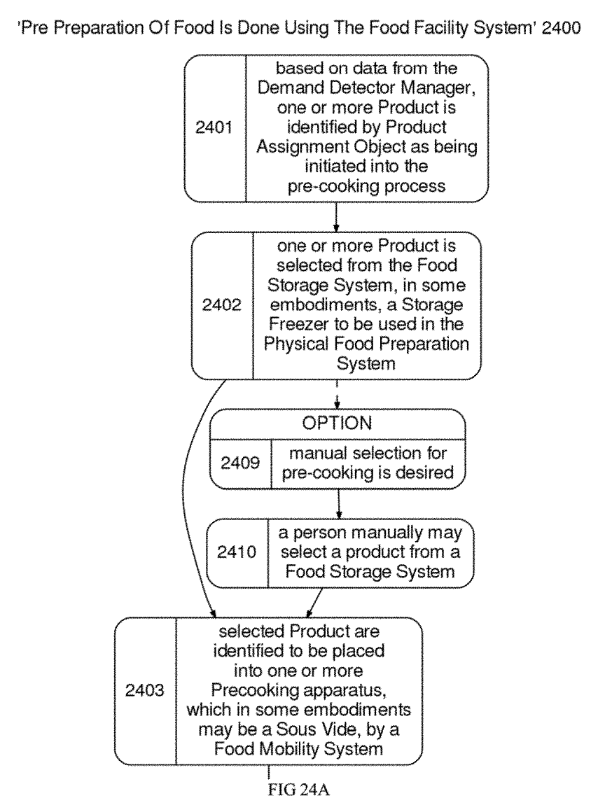

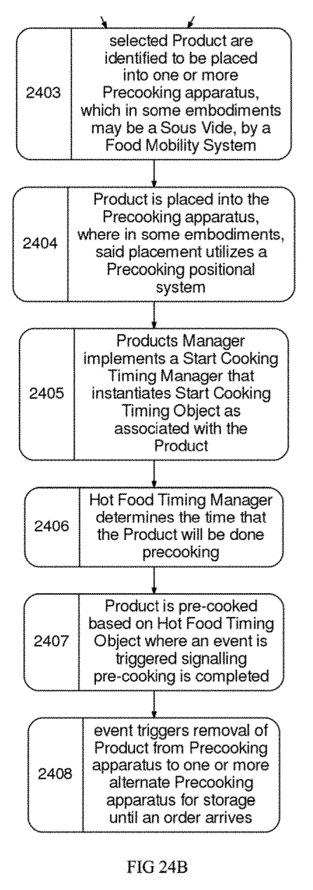

Referring now to FIG. 24, which shows pre-preparation of food is done using the food facility system. In a first step, based on data from the demand detector manager 533, one or more product 1337 is identified by product assignment object 810 as being initiated into the pre-cooking process (Step 2401). Next, one or more product 1337 is selected from the food storage system 516, in some embodiments, a storage freezer 1307 to be used in the physical food preparation system 513 (Step 2402). Next, selected product 1337 are identified to be placed into one or more precooking apparatus 1304, which in some embodiments may be, by a food mobility system 1306 (Step 2403). Next, product 1337 is placed into the precooking apparatus 1304, where in some embodiments, said placement utilizes a precooking positional system 1305 (Step 2404).

Next, products manager 1319 implements a start cooking timing manager 1321 that instantiates start cooking timing object 1413 as associated with the product 1337 (Step 2405). Next, hot food timing manager 1320 determines the time that the product 1337 will be done precooking (Step 2406). Next, product 1337 is pre-cooked based on hot food timing object 1412 where an event is triggered signaling pre-cooking is completed (Step 2407). Next, event triggers removal of product 1337 from precooking apparatus 1304 to one or more alternate precooking apparatus 1304 for storage until an order arrives (Step 2408). From Step 2402, if manual selection for pre-cooking is desired (Step 2409), then a person manually may select a product from a food storage system 516 (Step 2410). Next, refer to Step 2403.

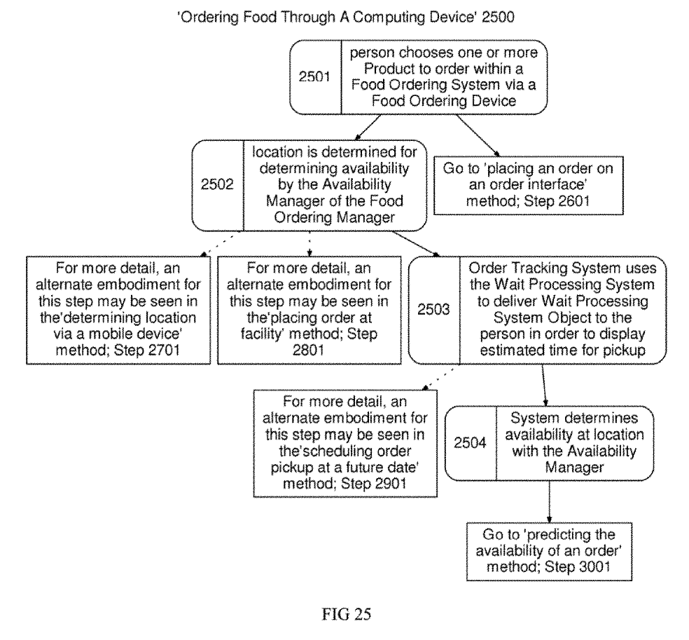

Referring now to FIG. 25, which shows ordering food through a computing device. In a first step, person chooses one or more product 1337 to order within a food ordering system 525 via a food ordering device 526 (Step 2501). Step 2501 is further detailed below in a related method (2600—‘placing an order on an order interface’). Next, location is determined for determining availability by the availability manager 909 of the food ordering manager 531 (Step 2502). In an alternative embodiment, Step 2502 may be performed as in Method (2700—‘determining location via a mobile device’).

Next, order tracking system 514 uses the wait processing system 1315 to deliver wait processing system object 1405 to the person in order to display estimated time for pickup (Step 2503). In an alternative embodiment, Step 2503 may be performed as in Method (2900—‘scheduling order pickup at a future date’). Next, System determines availability at location with the availability manager 909 (Step 2504). Step 2504 is further detailed below in a related method (3000—‘predicting the availability of an order’).

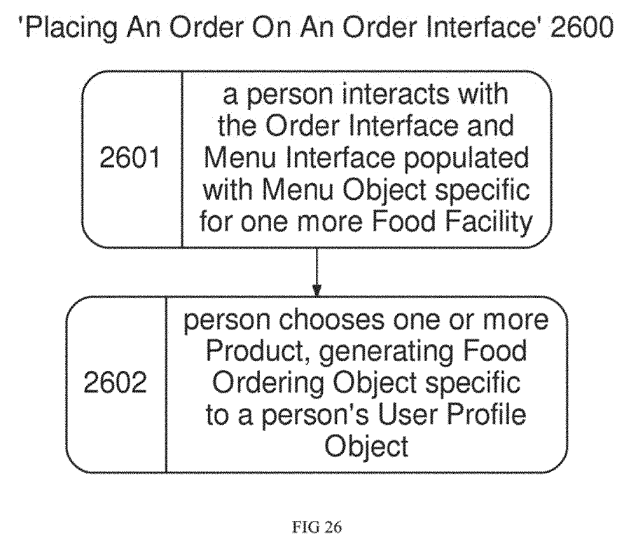

Referring now to FIG. 26, which shows placing an order on an order interface. In a first step, a person interacts with the order interface 901 and menu interface 902 populated with menu object 914 specific for one more food facility 512 (Step 2601). Next, person chooses one or more product 1337, generating food ordering object 530 specific to a person's user profile object 911 (Step 2602).

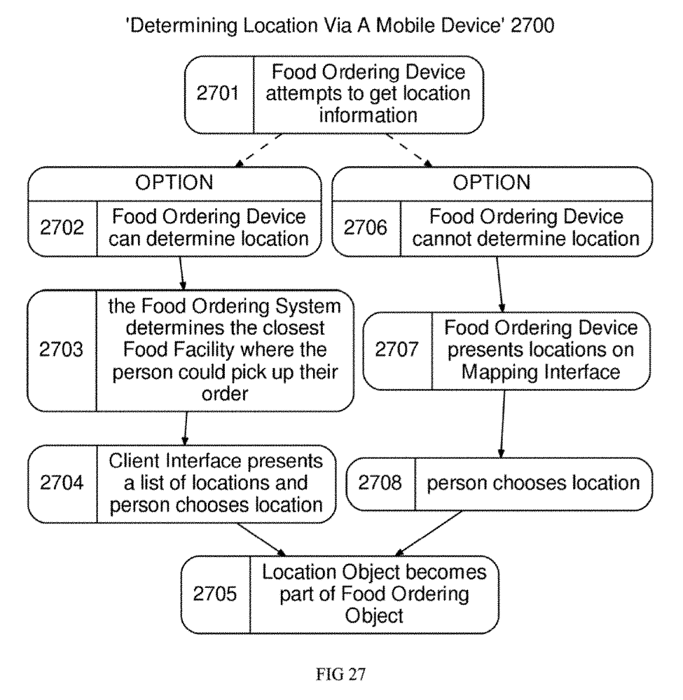

Referring now to FIG. 27, which shows determining location via a mobile device. In a first step, food ordering device 526 attempts to get location information (Step 2701). If food ordering device 526 can determine location (Step 2702), then the food ordering system 525 determines the closest food facility 512 where the person could pick up their order (Step 2703). Next, client interface 527 presents a list of locations and person chooses location (Step 2704). Next, location object 915 becomes part of food ordering object 530 (Step 2705).

From Step 2701, if food ordering device 526 cannot determine location (Step 2706), then food ordering device 526 presents locations on mapping interface 905 (Step 2707). Next, person chooses location (Step 2708). Next, refer to Step 2705.

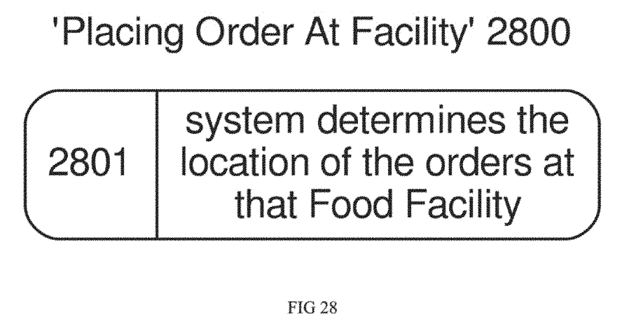

Referring now to FIG. 28, which shows placing order at facility. In a first step, system determines the location of the orders at that food facility 512 (Step 2801).

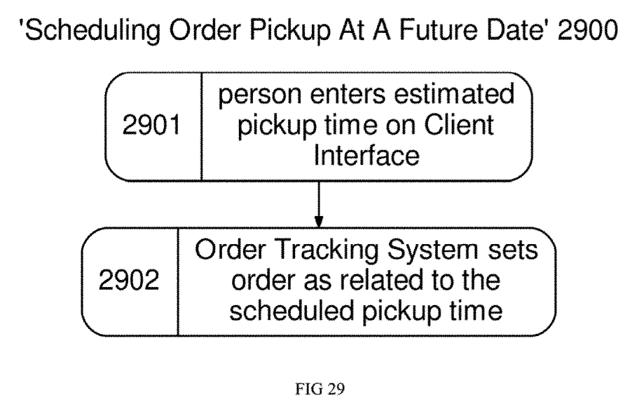

Referring now to FIG. 29, which shows scheduling order pickup at a future date. In a first step, person enters estimated pickup time on client interface 527 (Step 2901). Next, order tracking system 514 sets order as related to the scheduled pickup time (Step 2902).

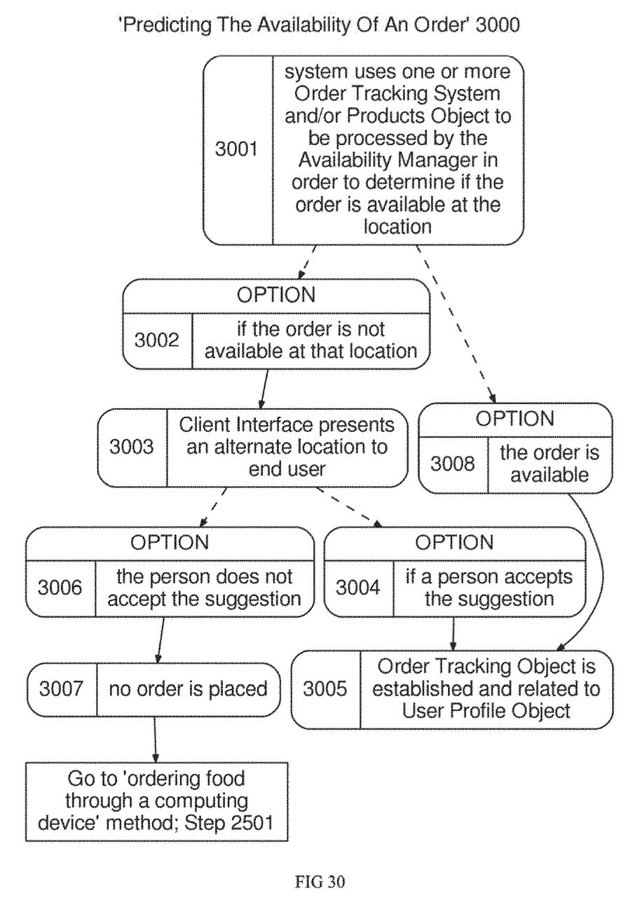

Referring now to FIG. 30, which shows predicting the availability of an order. In a first step, system uses one or more order tracking system 514 and/or products object 1411 to be processed by the availability manager 909 in order to determine if the order is available at the location (Step 3001). If the order is not available at that location (Step 3002), then client interface 527 presents an alternate location to end user (Step 3003). If a person accepts the suggestion (Step 3004), then order tracking object 1401 is established and related to user profile object 911 (Step 3005). From Step 3003, if the person does not accept the suggestion (Step 3006), then no order is placed (Step 3007). Step 3007 is further detailed below in a related method (2500—ordering food through a computing device’). From Step 3001, if the order is available (Step 3008), then refer to Step 3005.

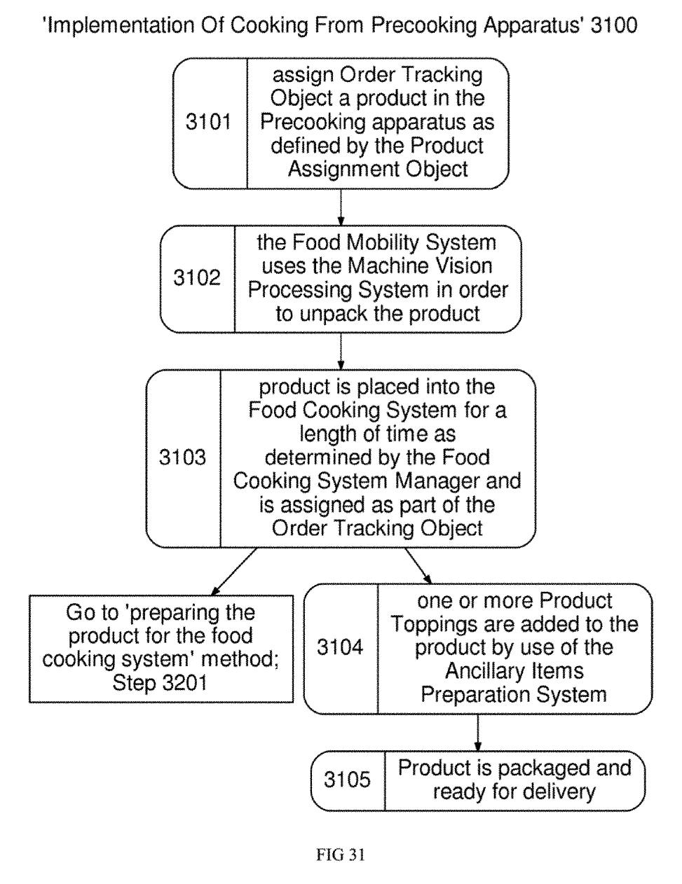

Referring now to FIG. 31, which shows implementation of cooking from precooking apparatus. In a first step, assign order tracking object 1401 a product in the precooking apparatus 1304 as defined by the product assignment object 810 (Step 3101). Next, the food mobility system 1306 uses the machine vision processing system 1314 in order to unpack the product (Step 3102). Next, product is placed into the food cooking system 1301 for a length of time as determined by the food cooking system manager 1325 and is assigned as part of the order tracking object 1401 (Step 3103). Step 3103 is further detailed below in a related method (3200—‘preparing the product for the food cooking system’). Next, one or more product toppings 1303 are added to the product by use of the ancillary items preparation system 1302 (Step 3104). Next, Product is packaged and ready for delivery (Step 3105).

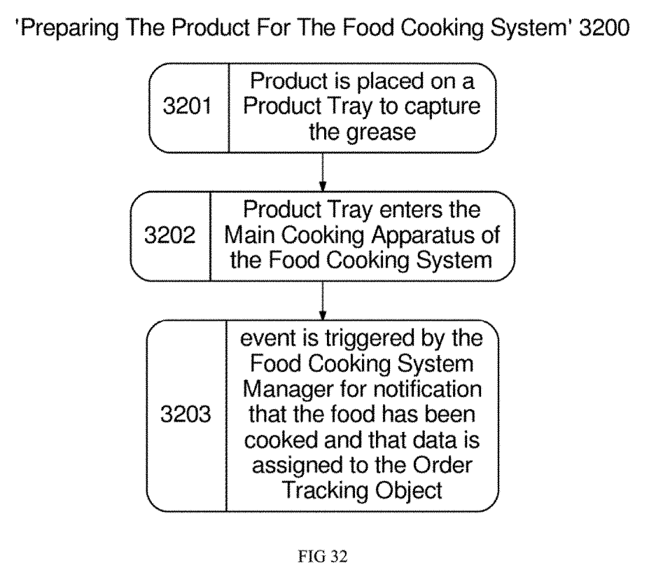

Referring now to FIG. 32, which shows preparing the product for the food cooking system. In a first step, product 1337 is placed on a product tray 1334 to capture the grease (Step 3201). Next, product tray 1334 enters the main cooking apparatus 1336 of the food cooking system 1301 (Step 3202). Next, event is triggered by the food cooking system manager 1325 for notification that the food has been cooked and that data is assigned to the order tracking object 1401 (Step 3203).

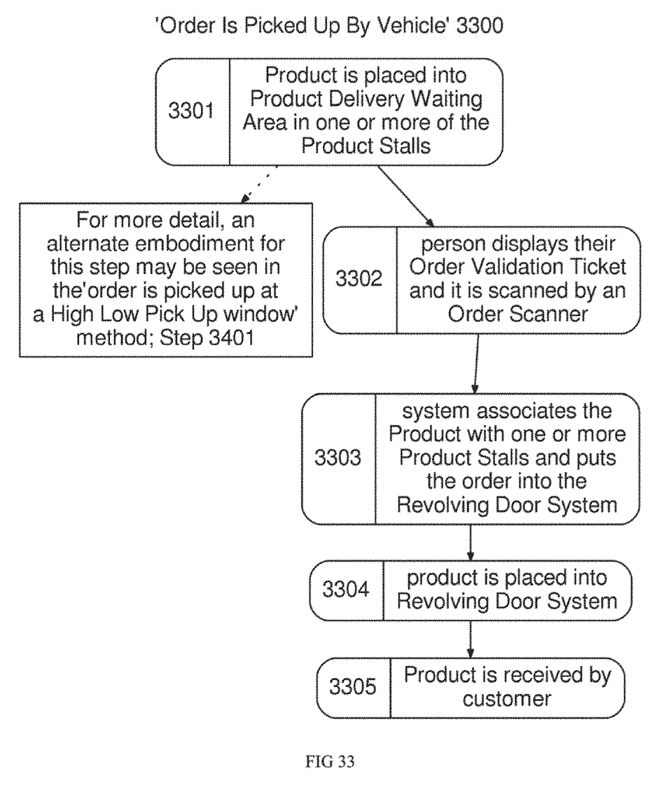

Referring now to FIG. 33, which shows order is picked up by vehicle. In a first step, product 1337 is placed into product delivery waiting area in one or more of the product stalls 1330 (Step 3301). In an alternative embodiment, Step 3301 may be performed as in Method (3400—‘order is picked up at a High Low Pick Up window’). Next, person displays their order validation ticket 1331 and it is scanned by an order scanner 1332 (Step 3302). Next, system associates the product 1337 with one or more product stalls 1330 and puts the order into the revolving door system 1335 (Step 3303). Next, product is placed into revolving door system 1335 (Step 3304). Next, product 1337 is received by customer (Step 3305).

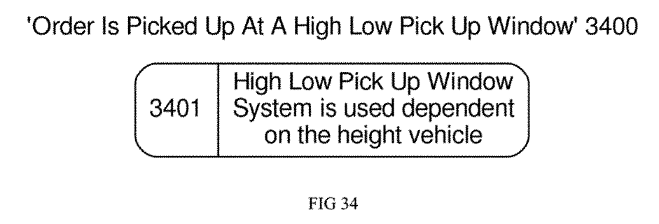

Referring now to FIG. 34, which shows order is picked up at a High Low Pick Up window. In a first step, high low pick up window system 1311 is used dependent on the height vehicle (Step 3401).

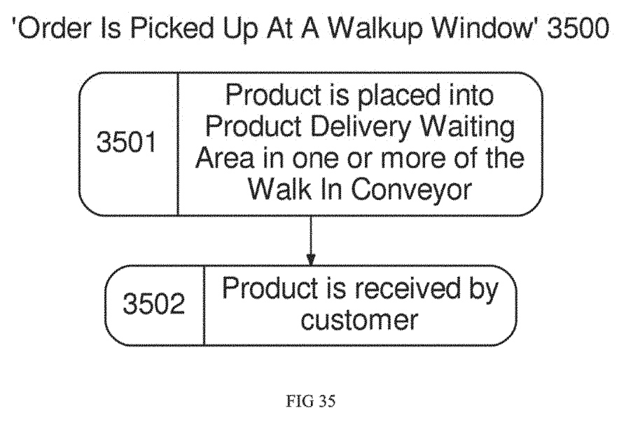

Referring now to FIG. 35, which shows order is picked up at a walkup window. In a first step, product 1337 is placed into product delivery waiting area in one or more of the walk in conveyor 1333 (Step 3501). Next, product 1337 is received by customer (Step 3502).

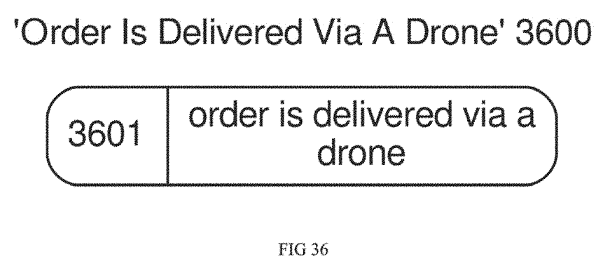

Referring now to FIG. 36, which shows order is delivered via a drone. In a first step, order is delivered via a drone (Step 3601).

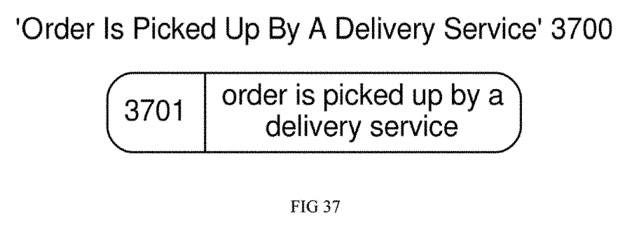

Referring now to FIG. 37, which shows order is picked up by a delivery service. In a first step, order is picked up by a delivery service (Step 3701).

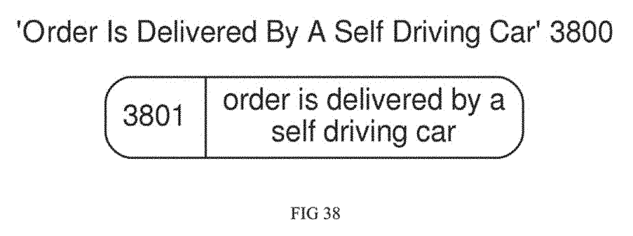

Referring now to FIG. 38, which shows order is delivered by a self driving car. In a first step, order is delivered by a self driving car (Step 3801).

The following elements and/or terms food distribution system, food distribution object, “delivery” embodiment, power supply, “facility ordering device” embodiment, local memory, physical ports, independent processor, interface memory, busses, program instructions, system server, system, embodiment, “steamer” embodiment, product delivery waiting area, “modular food facility” embodiment, “off site pre-cooking” embodiment, “robotic arm mobility system” embodiment, “conveyor mobility system” embodiment, mouse, keyboard and graphical user interface are important for the working functionality, but do not appear in the drawings and are shown below.

Food distribution system comprises one or more distributed systems that work in concert to automatically prepare one or more product 1337 within one or more food facility 512 that can be ordered by one or more customers. One goal of food distribution system is to allow one to have a wide variety of food options and distribution of cooked foods for ready availability for customers. Food distribution system preferably comprises delivery system 542, food distribution object, food ordering system 525, food facility inventory system 520, demand detector system 532, food product input system 501, food facility design system 507, visual demand detection system 537, food facility system 1201, and finally, notification system 545.

Food distribution object comprises one or more data objects and/or sub-data objects that store data for the food distribution system. One goal of food distribution object is to allow for means to manage the multiple sub systems by capturing their relevant properties and states.

“Delivery” embodiment comprises a system wherein an outside party receives an order and picks up the order at the food facility 512 and delivers it to a customer.

“Facility ordering device” embodiment comprises a computing device 101 that is geographically located at a food facility 512.

Local memory comprises one or more physical devices used to store programs (sequences of instructions) or data (e g. program state information) on a temporary or permanent basis for use in a computer or other digital electronic device, which may be configured to couple to the system in many different configurations. In some embodiments, it is thought that examples of local memory may include: non-volatile random access memory (RAM), read-only memory (ROM), or one or more levels of cached memory. Local memory functions to both 1) cache and/or store data and to 2) store programming instructions.

Physical ports comprises a specialized outlet on a piece of equipment to which a plug or cable connects.

Independent processor comprises a processor 104 that allow communication with with appropriate media. In some embodiments, it is thought that an example of independent processor could be audio processor or perhaps video processor and the like.

In some embodiments, it is thought that examples of interface memory may include: volatile and/or non-volatile memory (e.g., RAM), DDR, DDR2, or GDDR.

Busses comprises a communication system that transfers data between components inside a computer, or between computers.

Program instructions comprises a mechanism for control execution of, or comprise of an operating system, and/or one or more applications. In some embodiments, it is thought that examples of program instructions may include: object code, code produced by a compiler, machine code, code produced by an assembler or a linker, byte code, or code executed using an interpreter.

System server comprises a computing device 101.

“Steamer” embodiment comprises a precooking system wherein a steamer serves as the means by which precooking occurs.

Product delivery waiting area comprises an area of the food facility 512 where food is stored after final preparation until final delivery to the customer.

“Modular food facility” embodiment comprises a food facility 512 that is designed in some embodiments by the food facility design system 507 that can be modularly assembled in various configurations based on location, service type, and types for food prepared.

“Off site pre-cooking” embodiment comprises an embodiment wherein one or more product 1337 is cooked at an off-site location not within food facility 512 and later warmed at food facility 512.

“Robotic arm mobility system” embodiment comprises an embodiment where there are one or more mechanical three-point axis mobile arms that allow the moving of one or more food products throughout the order process and through the various systems, in order to deliver it to the customer.

“Conveyor mobility system” embodiment comprises an embodiment wherein one or more product 1337 is progressively prepared by transportation via conveyor to various preparation stations.

Mouse comprises a pointing device that detects two-dimensional motion relative to a surface.

Keyboard comprises a text entry interface to type text and numbers into a word processor, text editor or other programs.

Graphical user interface comprises a type of user interface that allows users to interact with electronic devices through graphical icons and visual indicators such as secondary notation, instead of text-based user interfaces, typed command labels or text navigation.

I claim:

1. A Food Distribution System comprising:
a. A communications network
b. A notification system
c. A Food Product Input System
d. A Demand Detector System
e. A Food Ordering System
f. A food facility Inventory System
g. A Visual Demand Detection System;
h. A Food Facility Design System; and
i. A Food Facility, wherein said food facility further comprises:
i. A Food Storage System,
ii. A Quality Control System,
iii. A Pick up System,
iv. A Sterility System,
v. A Power Source,
vi. An Order Tracking System, and
vii. A Physical Food Preparation System;

2. The system of claim 1 wherein said order tracking system further comprises:
a. A Geofencing prompting interface; and
b. A Food Processing System wherein said food processing system further comprises:
i. A reporting manager,
ii. A Machine vision Processing System,
iii. A Wait Processing System,
iv. A Reporting Manager,
v. A Third Party Delivery System,
vi. A Food Cooking System Product Distribution Manager,
vii. A Products Manager, and
viii. A Food Cooking System Manager.

3. The system of claim 2 wherein said physical food preparation system further comprises:
a. A Food Cooking System,
b. A Food Mobility System,
c. An Ancillary Items Preparation System,
d. A Precooking apparatus, and
e. A Main Cooking Apparatus.

4. The system of claim 3 wherein the Pick up System further comprises:
a. A Walk Up window,
b. A Product Delivery Waiting Area,
c. A Vehicle Picky up System,
d. A Walk in Conveyor,
e. A Product Tray,
f. A Revolving door System,
g. An Order Scanner,
h. An Order Validation Ticket, and
i. A Product Stalls.

5. The system of claim 4 wherein the vehicle puck up system further comprises a high low pick up window system.

6. The system of claim 1 wherein said physical food preparation system further comprises:
a. A Food Cooking System,
b. A Food Mobility System,
c. An Ancillary Items Preparation System,
d. A Precooking apparatus
e. A Main Cooking Apparatus.

7. A Food Distribution System comprising:
a. A communications network
b. A notification system
c. A Food Product Input System
d. A Demand Detector System
e. A Food Ordering System
f. A food facility Inventory System
g. A Visual Demand Detection System;
h. A Food Facility Design System; and
i. A Food Facility, wherein said food facility further comprises:
i. A Food Storage System,
ii. A Quality Control System,
iii. A Pick up System,
iv. A Sterility System,
v. A Power Source
vi. An Order Tracking System, and
vii. A Physical Food Preparation System; wherein said physical food preparation system further comprises:
1. A Food Cooking System,
2. A Food Mobility System,
3. An Ancillary Items Preparation System,
4. A Precooking apparatus, and
5. A Main Cooking Apparatus.

8. The system of claim 7 wherein said ancillary items preparation system further comprises a product toppings and the food storage system further comprises a storage freezer.

9. A Food Distribution System comprising:
a. A communications network
b. A notification system
c. A Food Product Input System, wherein said Food Product Input system further comprises:
i. A food Product Input device, wherein said food product input device further comprises a food product interface wherein said food product interface further comprises:
1. A Food Product Type Interface,
2. A Product Input Interface, and
3. A Product Cooking Plan Interface,
d. A Demand Detector System, wherein said demand detector system further comprises
i. A demand detector data,
ii. A demand detector manager, and
iii. A facility Demand System wherein said facility demand system further comprises a facility demand device,
e. A Food Ordering System wherein said food ordering system further comprises
i. A food ordering data,
ii. A food ordering manager, and
iii. A food Ordering Device wherein said food ordering device further comprises:
1. A Client interface,
2. A Food Ordering Processor, and
3. An Administrator Interface
f. A food facility Inventory System wherein said food facility inventory system further comprises:
i. A Food Facility Inventory Data,
ii. A Food Facility Inventory Manager, and
iii. A Food Facility Inventory Device, wherein said food facility inventory device further comprises a food facility inventory interface,
g. A Visual Demand Detection System wherein said visual detection system further comprises:
i. A Vehicle Detection System,
ii. A Line Detection System,
iii. A Visual Demand Detection Data, and
iv. A Visual Detection Manager;
h. A Food Facility Design System wherein said food facility design system further comprises a food facility design device wherein said food facility design device further comprises:
i. A Food Facility Interface
ii. A Facility Design Meta Data Interface, and
iii. A Product Facility Association Interface;
i. A Food Facility, wherein said food facility further comprises:
i. A Food Storage System,
ii. A Quality Control System,
iii. A Pick up System,
iv. A Sterility System,
v. A Power Source
vi. An Order Tracking System, and
vii. A Physical Food Preparation System; wherein said physical food preparation system further comprises:
1. A Food Cooking System,
2. A Food Mobility System,
3. An Ancillary Items Preparation System,
4. A Precooking apparatus, and
5. A Main Cooking Apparatus.

10. The system of claim 9 wherein the food distribution system further comprises a delivery system.

11. The system of claim 10 wherein the delivery system further comprises:
a. A delivery system data, and
b. A Delivery System Manager.

12. The system of claim 9 wherein said order tracking system further comprises:
f. A Geofencing prompting interface; and
g. A Food Processing System wherein said food processing system further comprises:
i. A reporting manager,
ii. A Machine Vision Processing System,
iii. A Wait Processing System,
iv. A Reporting Manager,
v. A Third Party Delivery System,
vi. A Food Cooking System Product Distribution Manager,
vii. A Products Manager, and
viii. A Food Cooking System Manager.

13. The system of claim 12 wherein said physical food preparation system further comprises:
h. A Food Cooking System,
i. A Food Mobility System,
j. An Ancillary Items Preparation System,
k. A Precooking apparatus, and
l. A Main Cooking Apparatus.

14. The system of claim 13 wherein the Pick up System further comprises:
a. A Walk Up window,
b. A Product Delivery Waiting Area,
c. A Vehicle Picky up System,
d. A Walk in Conveyor,
e. A Product Tray,
f. A Revolving door System,
g. An Order Scanner,
h. An Order Validation Ticket, and
i. A Product Stalls.

15. The system of claim 14 wherein the vehicle puck up system further comprises a high low pick up window system.
